(19) United States
(12) Patent Application Publication
(10) Pub. No.: US 2024/0241944 A1
(43) Pub. Date: Jul. 18, 2024

(54) SECURITY INTENTS AND TRUST COORDINATION FOR CLOUD NATIVE WORKLOADS

(71) Applicants: Ned M. Smith, Beaverton, OR (US); Kshitij Arun Doshi, Tempe, AZ (US); Adrian Hoban, Cratloe (IE); Eric W. Multanen, Portland, OR (US); Malini Bhandaru, San Jose, CA (US); Sunil Cheruvu, Tempe, AZ (US); Thijs Metsch, Bruehl (DE); Manjunath Ranganathaiah, Sunnyvale, CA (US); Anahit Tarkhanyan, Cupertino, CA (US); Sharad Mishra, Portland, OR (US); Igor Duarte Cardoso, Hillsboro, OR (US); Todd Malsbary, Seattle, WA (US); Bruno Vavala, Hillsboro, OR (US); Adarsh Chittilapplly, Hillsboro, OR (US); Subin John, Portland, OR (US); Alpesh Ramesh Rodage, Portland, OR (US)

(72) Inventors: Ned M. Smith, Beaverton, OR (US); Kshitij Arun Doshi, Tempe, AZ (US); Adrian Hoban, Cratloe (IE); Eric W. Multanen, Portland, OR (US); Malini Bhandaru, San Jose, CA (US); Sunil Cheruvu, Tempe, AZ (US); Thijs Metsch, Bruehl (DE); Manjunath Ranganathaiah, Sunnyvale, CA (US); Anahit Tarkhanyan, Cupertino, CA (US); Sharad Mishra, Portland, OR (US); Igor Duarte Cardoso, Hillsboro, OR (US); Todd Malsbary, Seattle, WA (US); Bruno Vavala, Hillsboro, OR (US); Adarsh Chittilapplly, Hillsboro, OR (US); Subin John, Portland, OR (US); Alpesh Ramesh Rodage, Portland, OR (US)

(21) Appl. No.: 18/619,826

(22) Filed: Mar. 28, 2024

Related U.S. Application Data
(60) Provisional application No. 63/456,310, filed on Mar. 31, 2023.

(51) Int. Cl. G06F 21/54

(52) U.S. Cl. CPC G06F 21/54; G06F 2221/033

(57) ABSTRACT

Various systems and methods are described for implementing security intents for the execution of workloads in cloud-to-edge (C2E) and cloud-native execution environments. An example technique for implementing security intents for a workload on a computing node of a cluster includes: identifying a workload for execution on the computing node; identifying security intents that define levels of respective security requirements for the execution of the workload on the computing node; adapting an execution environment of the computing node, based on the identified security intents; and controlling the execution of the workload within the execution environment, based on the identified security intents, to dynamically monitor and adapt to changing security conditions during the execution of the workload.

### PRIORITY CLAIM

This application claims the benefit of priority to U.S. Provisional Patent Application No. 63/456,310, filed Mar. 31, 2023, and titled “CLOUD TO EDGE SECURITY”, which is incorporated herein by reference in its entirety.

### BACKGROUND

Edge computing, at a general level, refers to the transition of compute and storage resources closer to endpoint devices (e.g., consumer computing devices, user equipment, etc.), in order to optimize total cost of ownership, reduce application latency, improve service capabilities, and improve compliance with compute security or data privacy requirements. Edge computing may, in some scenarios, provide a cloud-like distributed service that offers orchestration and management for applications among many types of storage and compute resources.

Some implementations of edge computing have been referred to as the “edge cloud” or the “fog,” as powerful computing resources previously available only in large remote data centers are moved closer to endpoints and made available for use by consumers at the “edge” of the network. The use of edge computing, and the many flavors of distributed or centralized cloud computing, have led to a variety of technical issues involving security, reliability, and resource usage.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram illustrating a trusted cloud-to-edge services framework, according to an example;

FIG. 2 is a block diagram illustrating the components of a Container-as-a-Service layer, according to an example;

FIG. 3 is a block diagram illustrating the components of a Platform-as-a-Service layer, according to an example;

FIG. 4 is a block diagram illustrating the components of an Infrastructure-as-a-Service layer, according to an example;

FIG. 5 is a block diagram illustrating various Infrastructure-as-a-Service layers and trust management capabilities, according to an example;

FIG. 6 is a block diagram illustrating a workflow of a workload, according to an example;

FIG. 7A is a block diagram illustrating a high-level representation of an intent-driven orchestration system, according to an example;

FIG. 7B is a block diagram illustrating a high-level representation of an intent-driven orchestration system adapted for use with security intents, according to an example;

FIG. 8 is a block diagram illustrating characteristics and definition formats of security intents, according to an example;

FIG. 9A is a diagram illustrating the elements of a hyperconnected compute continuum, according to an example;

FIG. 9B illustrates the use of a trust coordination as a service, according to an example;

FIG. 10 is a diagram illustrating trust coordination, according to an example;

FIG. 11 illustrates existing approaches and the advancement to a trust coordination framework, according to an example;

FIG. 12 is a diagram illustrating interoperability of the trust coordination service, according to an example;

FIG. 13 is a block diagram illustrating a general hierarchy of classes and attributes, according to an example;

FIG. 14 is a block diagram illustrating a specific hierarchy of classes and attributes, according to an example;

FIG. 15 is a block diagram illustrating a trust coordination framework architecture, according to an example;

FIG. 16 is a block diagram illustrating high-level operations in a trust coordination framework architecture, according to an example;

FIG. 17 is a block diagram illustrating state transitions of trustworthiness attributes, according to an example;

FIGS. 18-20 are swim lane diagrams illustrating interactions between components of a trust coordination framework architecture, according to various examples;

FIG. 21 is a flowchart illustrating operations for implementing security intents at a computing node, for coordinating execution of cloud-native or cloud-to-edge workloads, according to an example;

FIG. 22 is a flowchart illustrating operations for implementing security intents at an orchestrator of a compute cluster, for coordinating execution of cloud-native or cloud-to-edge workloads among one or more computing nodes in the cluster, according to an example;

FIG. 23 illustrates an overview of an edge cloud configuration for edge computing, according to an example;

FIG. 24 illustrates deployment and orchestration for virtual edge configurations across an edge-computing system operated among multiple edge nodes and multiple tenants, according to an example;

FIG. 25 illustrates a vehicle compute and communication use case involving mobile access to applications in an edge-computing system, according to an example;

FIG. 26 illustrates a block diagram depicting deployment and communications among several Internet of Things (IOT) devices, according to an example;

FIG. 27 illustrates an overview of layers of distributed compute deployed among an edge computing system, according to an example;

FIG. 28 illustrates an overview of example components deployed at a compute node system, according to an example;

FIG. 29 illustrates a further overview of example components within a computing device, according to an example; and

FIG. 30 illustrates a software distribution platform to distribute software instructions and derivatives, according to an example.

### DETAILED DESCRIPTION

In the following description, methods, configurations, and related apparatuses are disclosed for implementation in a cloud-to-edge (C2E) framework. As used herein, “cloud-to-edge” generally refers to functionality to move workloads and capabilities that were traditionally located in a cloud computing setting towards distributed edge computing locations. Such functionality is particularly applicable to the deployment and execution of elastic workloads (WLs), which involve workloads that are distributed across multiple nodes, migrated, and dynamically coalesced.

Edge computing has introduced scenarios involving elastic workloads where a traditional monolithic workload, which may run on a single cloud or Edge node, may be decomposed into two or more sub-workloads that are distributed across multiple Edge nodes. The distributed workload may be partially or fully consolidated or decomposed even further to accommodate the changing resource dynamics of edge-cloud deployments for both stationary and mobile users and user equipment, or stationary and mobile edge nodes. These dynamics creates an environment for elastic edge computing capabilities that include dynamic binding of workloads, resources, and compute.

The use of elastic workloads and heterogeneous edge computing capabilities can involve compute actions taken among different clusters, hardware, orchestrators, and many entities. In this context, a large concern involves security, and whether tasks can securely launch if a cloud-native, elastic workload can be run “anywhere” and at any time. To address this concern, the following introduces the use of “security intents”, applicable to settings involving elastic WLs and static WLs. These intents are definitions that provide specific security properties and objectives to be achieved during workload execution. These security intents operate in a manner similar to intent-driven orchestration, where high-level SLAs and requirements are adapted to the use of edge computing resources based on defined intents. However, the presently described security intents also adapt resources to address security concerns, including with both static and dynamic aspects involved with elastic workload execution.

### Trusted Cloud-to-Edge Framework

The use of elastic WLs can provide flexibility to accommodate distribution and dynamism inherent in edge computing. A dynamic C2E framework can ensure that trust within a complex elastic WL infrastructure is preserved throughout the many types of WL configurations and use cases.

Container-as-a-service (CaaS), platform-as-a-service (PaaS), and infrastructure-as-a-service (IaaS) capabilities expect that trust is established statically at an initial deployment of a WL, and such capabilities generally will not re-evaluate trust during WL execution. The dynamics of an elastic WL in an C2E deployment, however, change the WL from being a monolithic WL to a distributed WL having dynamic properties that distribute the WL processing across multiple nodes. This is further complicated because nodes may dynamically migrate to other hosting environments at lower framework layers, resulting in broken trust semantics.

The systems and methods described herein implement an elastic WL framework with security and trust capabilities at operational layers involving workload execution environments (e.g., containers, virtual machines, etc.), platforms, and infrastructure, and these layers' associated services (Container-as-a-Service (CaaS), Platform-as-a-Service (PaaS), and Infrastructure-as-a-Service (IaaS)). The following systems and methods use a Trust Binding Manager to actively monitor and apply trust bindings between the artifacts at respective layers that require consistent trust properties, while responding to dynamic conditions that otherwise will break trust properties. This enables elastic WL frameworks to establish and preserve intended trust properties of a WL throughout the WL execution and lifecycle despite the occurrence of dynamic changes in resources, location, and data sources/sinks.

A trusted C2E services framework for elastic workloads is adapted as follows to ensure various “anything-as-a-service” (X-aaS) capabilities in a services framework. This is used to establish and maintain trust within the respective framework layers, e.g., CaaS, PaaS, and IaaS, and between C2E framework layering, e.g., CaaS to PaaS, and PaaS to IaaS. The Trust Binding Manager component is used to establish and maintain trust properties for an elastic WL that is implemented using a trusted C2E framework. The C2E framework integrates a Trust Binding Manager component that enables creation, simulation, deployment, and maintenance of trusted elastic WLs following a WL lifecycle.

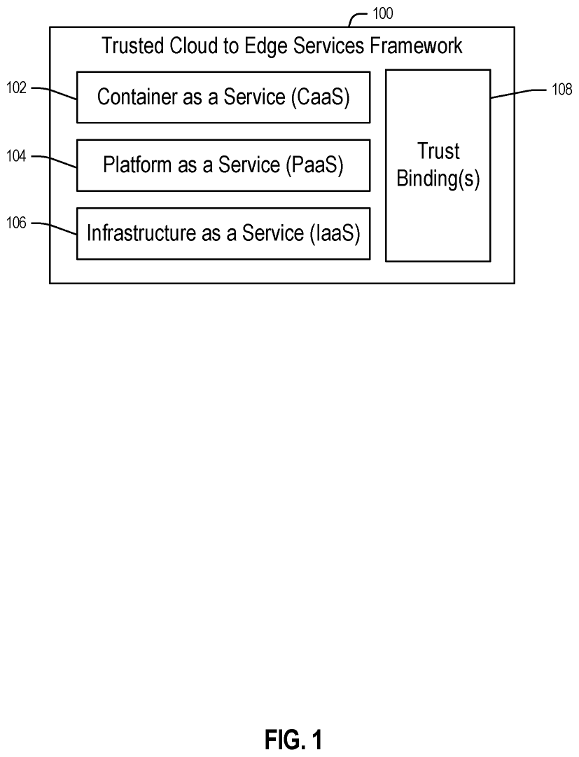

FIG. 1 is a block diagram illustrating an example of a trusted cloud-to-edge (C2E) services framework 100, according to an example. The trusted C2E services framework 100 includes a Container-as-a-Service (CaaS) layer 102, a Platform-as-a-Service (PaaS) layer 104, and an Infrastructure-as-a-Service (IaaS) layer 106, which are managed by using trust bindings 108. In other examples, a PaaS layer is operated above a CaaS layer, such as when the PaaS layer adds an application runtime layer over the container services.

The CaaS layer 102 creates a uniform abstraction for describing a workload that is independent of a particular platform. A distributed WL may partition the WL into logical sub-workloads that are related by a workflow model where the partial results from one sub-workload may be input to another sub-workload. The workflow may divide WL computations into execution operations that are in a particular sequence or in a particular concurrence. An individual sub-workload should have the same trust semantics as the monolithic WL. Monolithic WL trust may be established as part of an SLA (service level agreement) between the WL tenant and a WL service provider. Elastic WL execution may result in a distributed WL having multiple sub-workloads hosted by many nodes. The WL partitioning and execution workflow may introduce challenges to trust where the expected trust agreed to initially as part of an SLA agreement may disappear due to differences in platform and infrastructure options introduced by PaaS and IaaS framework layers.

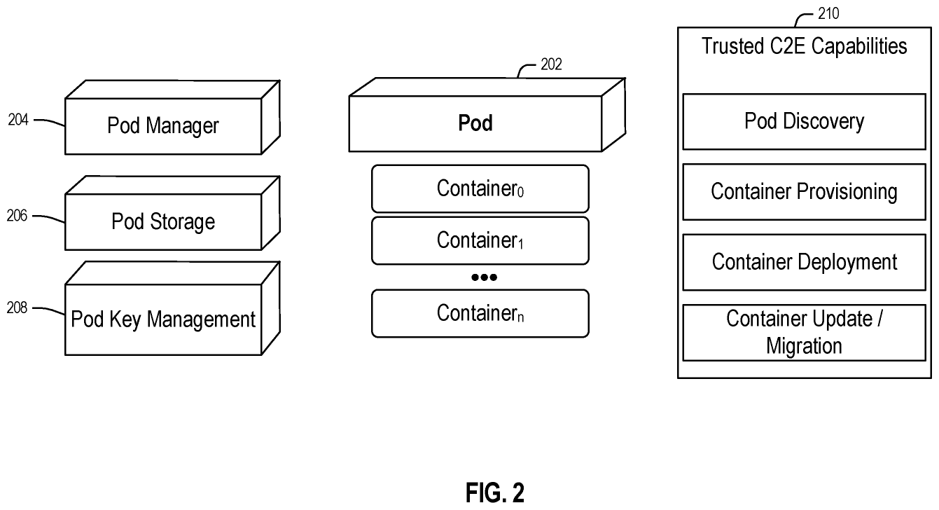

FIG. 2 is a block diagram illustrating the components of an example CaaS layer (e.g., corresponding to layer 102), according to an example. Here, a pod 202 is used to deploy multiple containers (labeled as container 0 to container n). Functionality used in the CaaS layer includes a pod manager 204, pod storage 206, and pod key management 208. The features discussed herein introduce the use of trusted C2E capabilities 210 for the CaaS layer, which include but are not limited to: pod discovery; container provisioning; container deployment; and container update or migration. Although references to a “pod” may refer the use of a pod in a Kubernetes deployment, other types of container management and container deployment systems may also be used.

Returning to FIG. 1, the PaaS layer 104 creates a uniform platform abstraction that facilitates workload deployment where the sub-workload fragments of a distributed workload execute within one or more virtual and physical platform environments. The PaaS layer 104 abstraction hides hardware, system software, and cloud platform specific artifacts so that the workload designer does not need to adapt the workload to differences found at lower layers. The PaaS layer 104 abstraction also hides trust properties inherent to lower layers resulting in workloads that ignore the risks associated with untrusted hosting environments. In general, PaaS may depend on additional infrastructure layers that may themselves have layer abstractions and packaged as services (e.g., IaaS, hardware-as-a-service (HWaaS), etc.). Workload designers may not be aware of the various deployment options available at infrastructure layers. The services ecosystem may outsource some or all of workload deployment to a services abstraction. Consequently, workload security policies may need to be adapted, translated, and negotiated to the specific security postures at respective infrastructure layers and with respective service providers.

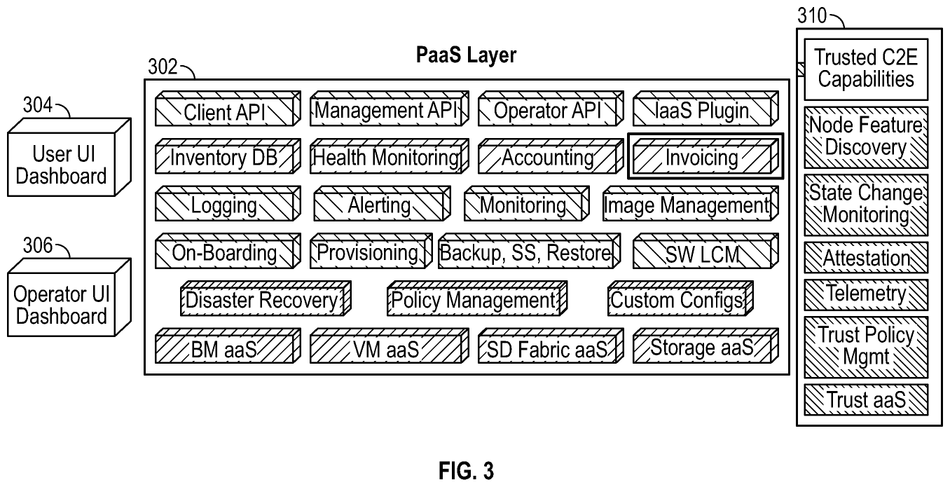

FIG. 3 is a block diagram illustrating the components of a PaaS layer (e.g., corresponding to layer 104), according to an example. Here, a PaaS layer 302 includes a variety of APIs, functions, and services to host and operate the platform. The PaaS layer 302 is operably coupled with a user (e.g., services user) dashboard UI 304 and an operator (e.g., administrator) dashboard UI 306 to invoke use of these APIs, functions, and services. The features discussed herein introduce the use of trusted C2E capabilities 310 for the PaaS layer, which include but are not limited to: node feature discovery; state change monitoring; attestation; telemetry; trust policy management; and trust services (e.g., in a “trust-as-a-service” or “TaaS” implementation). Other aspects such as an applciation runtime environment are not depicted for purposes of simplicity.

Returning to FIG. 1, the IaaS layer 106 creates a uniform interface for allocating WL resources, e.g., compute, memory, storage, and communication that satisfy expected performance and availability requirements as specified by an SLA. The infrastructure has physical security properties such as a hardware root of trust (RoT), secure storage for keys, trusted software, and protection of secret data. Mechanisms for discovering and attesting the trustworthiness properties of the IaaS resources need to be built into the IaaS infrastructure or trust in the upper C2E framework layers cannot be guaranteed.

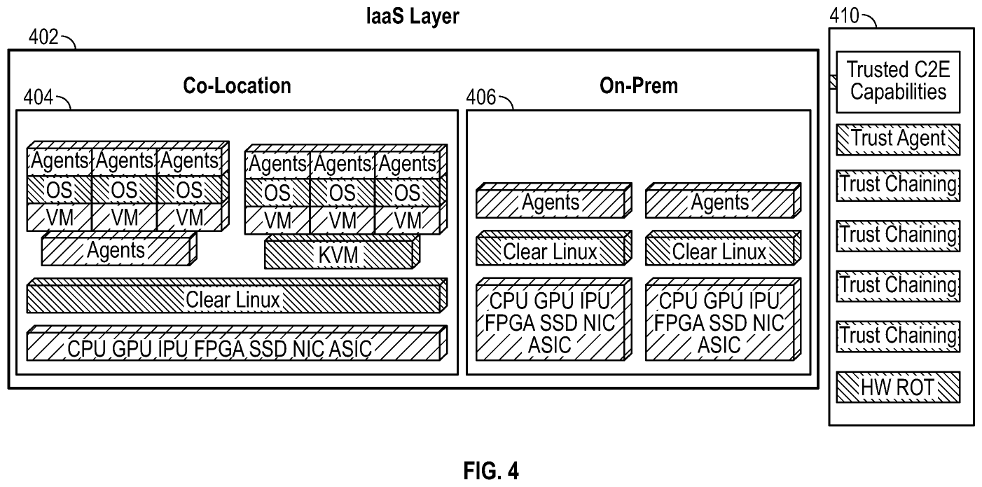

FIG. 4 is a block diagram illustrating the components of an IaaS layer (e.g., corresponding to layer 106), according to an example. The IaaS layer 402 of FIG. 4 depicts the use of co-located computing resources 404, and on-premise computing resources 406. A variety of types of computing scenarios involving virtual machines, operating systems, and hardware is also depicted. Although some specific types of operating systems (e.g., Linux) and hypervisors (e.g., KVM) are depicted, other types of operating systems and virtual machine monitors may be used. The features discussed herein introduce the use of trusted C2E capabilities 410 for the IaaS layer, which include but are not limited to: a trust agent; trust chaining (including multiple instances of such trust chaining); and a hardware root of trust.

The systems and methods described herein provide CaaS, PaaS, and IaaS layers with trusted computing capabilities that ensures the security and trust properties of the workload are represented and enforced at appropriate CaaS, PaaS, and IaaS layers. With use of the aforementioned trusted C2E capabilities, security and trust can be provided even if every infrastructure layer has an X-aaS abstraction.

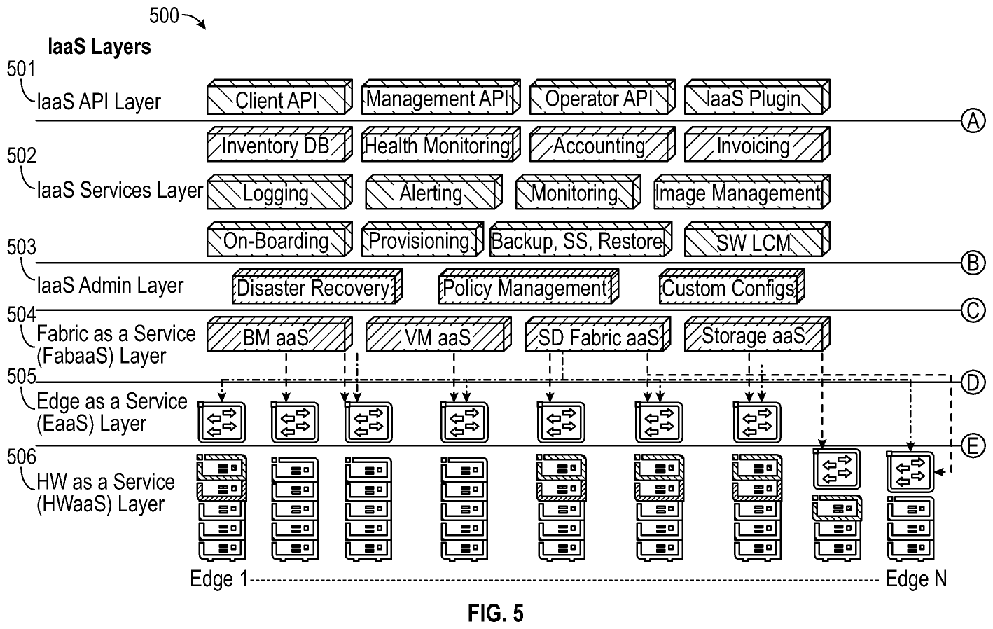

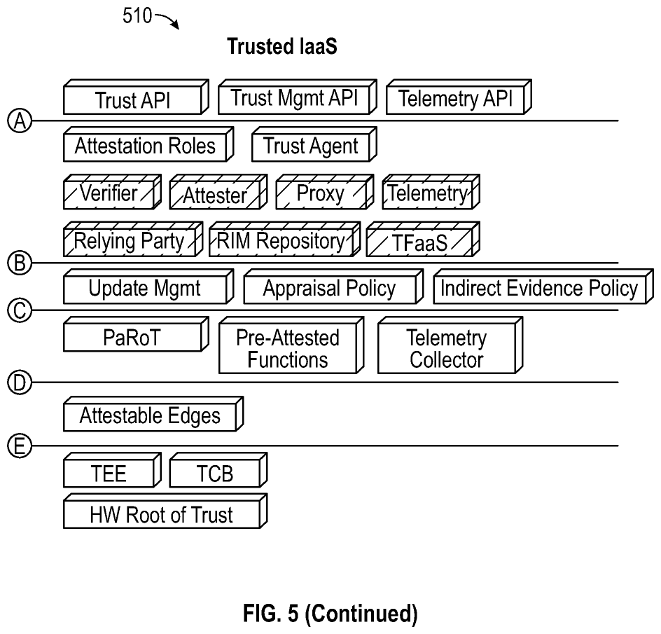

FIG. 5 is a block diagram illustrating additional aspects of IaaS layers and trust management capabilities, according to an example. The IaaS layers 500 depicted in FIG. 5 may include aspects such as: an API layer 501; a services layer 502; an admin layer 503; a Fabric-as-a-Service layer 504; an Edge-as-a-Service layer 505; and a Hardware-as-a-Service layer 506.

The IaaS layers 500 are adapted to provide trusted computing capabilities, using features of a trusted IaaS environment 510 that are supplied by trusted hardware. The relevant trusted computing capabilities include but are not limited to: HW roots of trust, trusted execution environments, security algorithm acceleration, network isolation, audit status, edge attestation, attestation evidence collector/lead attester (e.g., Open Compute Project Platform Active ROT, “PA ROT”), pre-attested functions, trusted telemetry collection, update management, appraisal policies, evidence policies, attestation ecosystem roles, and interfaces for the underlying trust, management, and telemetry capabilities.

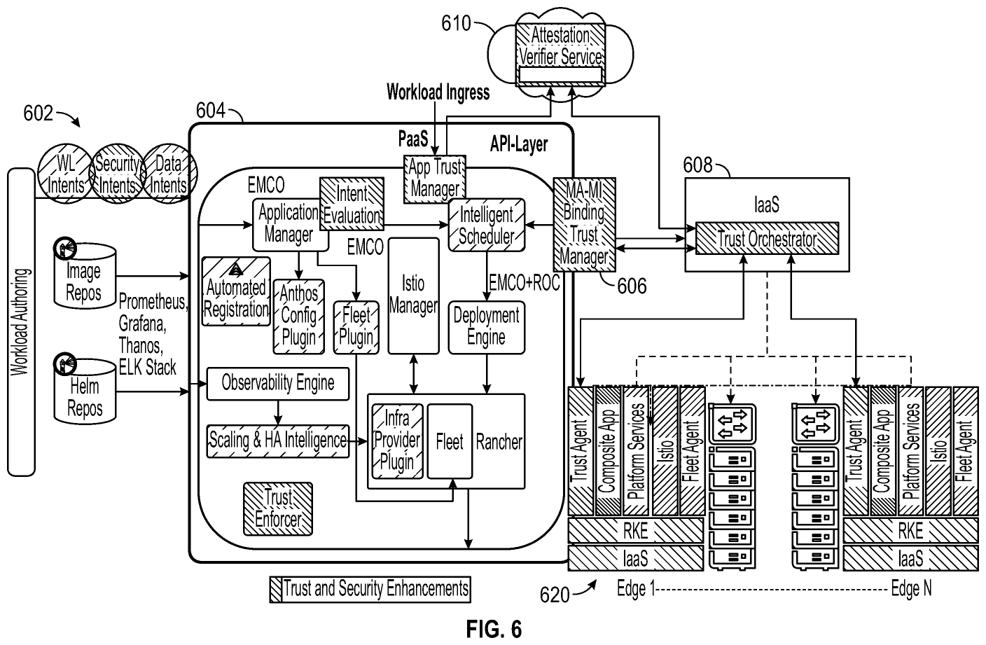

FIG. 6 is a block diagram illustrating a workflow of a workload, according to an example. The C2E framework provides trust capabilities that are also integrated in a PaaS layer 604, with the use of a trust binding manager 606. The trust binding manager 606 links trusted resources with trusted containers such that the binding between a container, platform, and resource is verifiable by another entity such as an attestation verifier service 610. This enables an IaaS layer 608 to successfully distribute the workloads to resources at one or more edge computing locations 620. Although FIG. 6 depicts specific examples of an orchestrator (EMCO, Rancher), service mesh (Istio), container manager (Anthos), workload specification formats (Docker files), and visualization/data collection tools (Grafana, Prometheus), it will be understood that other tools, services, and data formats may be used.

Trust in the container begins as part of workload authoring where the WL author supplies security intents and other intents metadata 602 that describes the parameters of trust such as expected attestation values and results. Workload authoring may also include elastic WL properties that aid in decomposing a monolithic WL into distributable parts using metadata in the form of WL intents, security intents, and data intents. This metadata may describe expected or allowed WL, module, and data composition/decomposition points as well as data ingress/egress behavior for WL nodes that optimize for remote data hosting with data flow ingress/egress. Additionally, data sensitivities are described by metadata that include policies that describe safe HW and SW environments where sensitive data may be safely and confidentially manipulated such as Intel® SGX/TDX, ARM® TrustZone, AMD® SEV, etc.

### Security Intents and Security Realization for Elastic Workloads

Security is complex and complicated in a Cloud Native or in a Cloud-to-Edge Elastic Workload context, where containerized workloads are launched in clusters that reside in the cloud-to-edge continuum. Clusters may have varied hardware (e.g., multi-vendor, multi-generation components from a single or multiple vendors), different cluster orchestrators (e.g., different flavors of Kubernetes provided by Red Hat®, SUSE™, Ubuntu Canonical™, etc.), different operating systems, and different kernels further down the Cloud Native stack—all of which may be updated or patched at different intervals. In this context, security tasks, oversight, and securing workloads amidst the diversity of hardware and software become a significant concern.

Security measures are complicated by static aspects and dynamic aspects of workload execution. Even when a system is following best practices, there may be a number of dynamic aspects of security risks that only arise during time of the execution. For example, the workload itself might have dependencies, so the security risk might only become apparent at a later time (e.g., days, weeks, months, years after the initial deployment) when the dependencies are invoked during execution. There may also be a concern of a security risk in the workload itself or an action involved with the workload, including whether the resource or action involved in the workload has been previously exploited, or is subject to a newly discovered vulnerability.

Even if only a single node is used for workload execution, a security concern might involve whether there are other workloads executing on the same node that are vulnerable or have a dependency that is exploitable. This type of evaluation becomes more difficult in cases where a single workload might have one set of vulnerabilities and other workloads might have a different set of vulnerabilities, and yet heterogeneous edge computing environments may want to handle these workloads concurrently.

The following discusses aspects of implementable security intents that are actuated in Cloud Native and elastic workload contexts. The following approaches seek to let developers develop workloads that operators can deploy anywhere, with an accompanying security intent. The use and adaptation to security intent definitions can help eliminate the need for developers or implementers to plan for all permutations of hardware, software, and infrastructure capabilities. A security intent as discussed herein is a definition of security features or requirements, which includes some set of multiple expressed primitives related to security aspects such as confidentiality, integrity, isolation, auditability, etc. Security intents can be customized to a given containerized or non-containerized workload based on the workload's application context needs, for instance, to enable the containerized workload to be rendered with more security or less security. Accordingly, the security primitives allow control of the defined aspects to ensure that properties such as confidentiality, integrity, auditability can be successfully met, and that appropriate remedial measures can enhance security functionality when needed.

The following thus introduces the definition and use of security intent primitives to enable more granular development and security oversight. These primitives can help quantify a security risk to other workloads running on shared infrastructure, which could prompt the migration of a high-value workload to run in a legacy virtual machine or possibly even in a confidential virtual machine. The following also extends an Intent-Driven-Orchestration framework to launch workloads to meet security needs and monitor them over a lifecycle per configured security policies (while also meeting Key Performance Indicators (KPIs) such as cost or performance). Consequently, this reduces security risk to individual workloads and other workloads running on the shared infrastructure. By quantifying security risk and the cost-benefit analysis of different approaches, security can be handled by a general intent-driven framework that can weigh different axes of data values such as cost, performance, and the like. Accordingly, this approach with security intents extends the concepts provided by intent-driven orchestration, with such concepts extended to handle security.

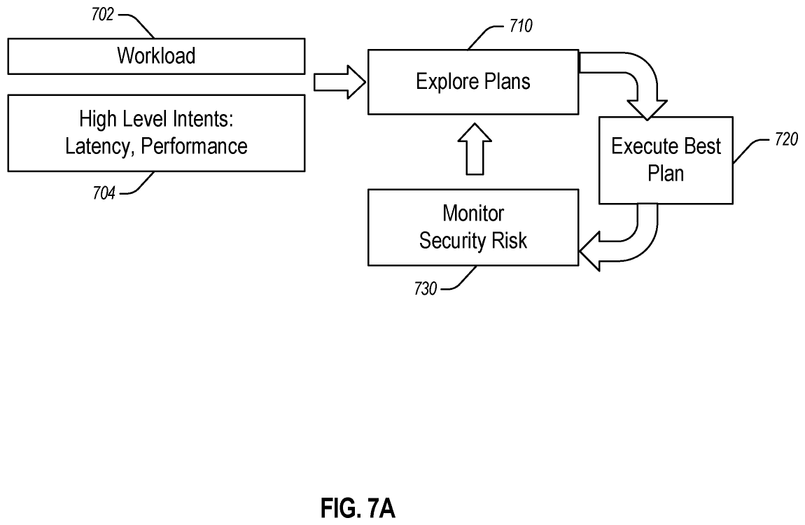

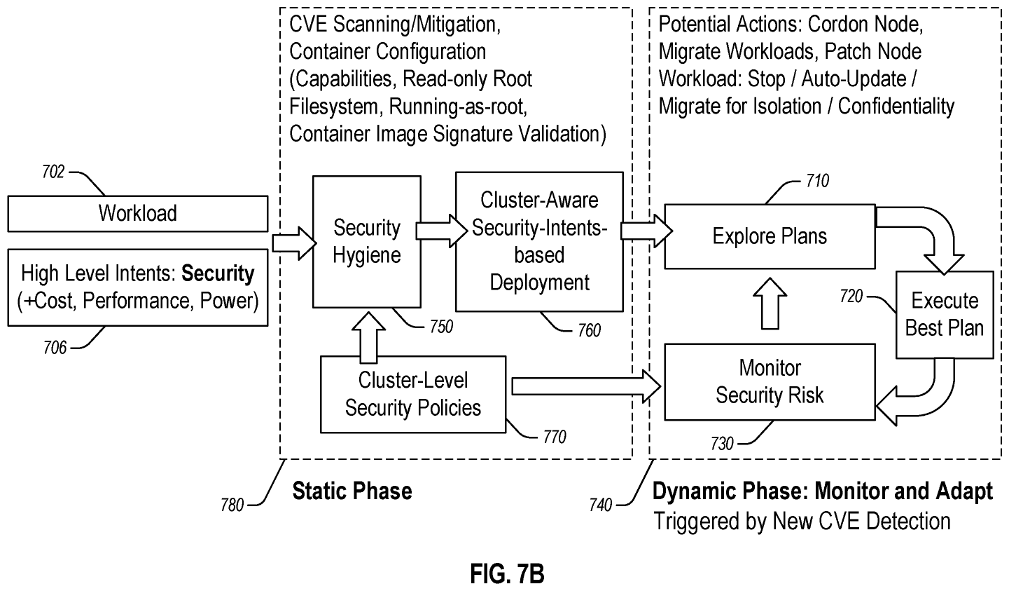

FIG. 7A depicts a high-level representation of an intent-driven orchestration system with Inputs, Planning, Execution, and Monitoring components laid out. This diagram is simplified, as it will be understood that other functional components of intent-driven orchestration may be used. In intent-driven orchestration, a workload 702 is accompanied by high-level intents 704. The high-level intents 704 may specify some details of workload execution, such as target latency or performance metrics (including those metrics corresponding to a service level objective or service level agreement). Based on these intents, various execution plans 710 are evaluated and explored, and a “best” execution plan is selected and executed 720.

The execution of the best plan 720 is used to implement various aspects of the workload processing based on the high-level intents 704. Periodic or event-driven monitoring is used to detect deviations in the desired state, which trigger re-planning and corrective actions. Thus, with the basic framework of intent-driven orchestration, some level of security risk monitoring 730 may be used. However, the security risk monitoring 730 may simply lead to the selection of another execution plan 710.

The use of high-level intents 704 in these and similar settings may be extended to introduce security details from security-specific intents and primitives. No longer will an end user need to specify all characteristics of security in the plan details, which requires in-depth knowledge like the vendor hardware platform or container runtime. Rather, the requirements of the security setting itself can be pre-defined and evaluated dynamically, depending on the type of deployment and setting.

In some examples, even customers and end users can provide and update a workload specification that provide aspects of security intents. For the execution of cloud-native workloads, this may include modifying a Helm chart, Docker-compose file, Docker file, YAML file, or XML file. Alternately in no-code/low-code environments, this may involve the selection of a user interface option to specify high-level application security intents. In addition to these specifications, components can be provided in the cloud infrastructure (e.g., running as services) to comprehend input, weigh alternatives to realize the requested capabilities, and transform the request specification based on the high-level intents. For instance, these components can be visible when listing the control-related containers/services running in the system.

FIG. 7B depicts a high-level representation of an intent-driven orchestration system adapted for use with security intents. Specifically, this figure depicts the use of security intents 706, based on enhancements to an intent-driven orchestration framework. These enhancements include static phase operations 780 (or, outer-loop dynamic phase operations) and dynamic phase operations 740 (or, inner-loop dynamic phase operations) for execution of the workload 702.

The static phase operations 780 and dynamic phase operations 740 generally correspond to static aspects and dynamic aspects of assessing and implementing security measures. Such aspects of security risks may include evaluating the workload or the system for Common Vulnerabilities and Exposures (CVEs, e.g., publicly disclosed computer security flaws), evaluating the particular configuration of a container used with the workload (e.g., capabilities, signature validation), and the application and verification of security policies on a node or cluster-based level. As an example, dynamic aspects of security risks include those risks noted above, with the additional consideration of security conditions encountered at runtime of the specific workload. Such conditions at runtime may be caused by conditions such as: the workload itself may have dependencies; specific vulnerabilities may have different levels of risk or exploitation; different types of vulnerabilities may exist; workload dependencies may be vulnerable, or the workload dependency might be exploitable; other workloads might attack a particular workload; or a workload might have its own vulnerabilities and other workloads might have their own vulnerabilities.

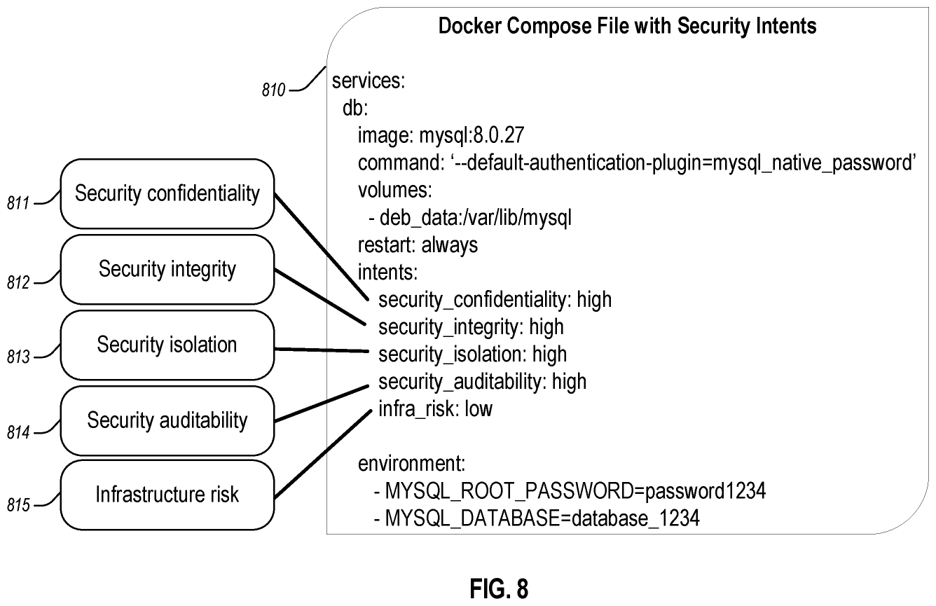

In an example, the security intents 706 are provided within incoming requests associated with the workload (discussed in more detail in FIG. 8, below). The security intents 706 may define properties with designations such as “confidentiality”, “auditability”, and the like, and the level of security requested, targeted, required, or specified may be related to aspects such as cost, performance, and power. Such designations may be provided with the use of high-level tags and values. The security intents 706 may be expressed in a variety of formats for the tags and values. For designations such as performance and latency, a numeric desired state (e.g., defined as a value from 0 to n) can drive a plan-execute-sense loop.

In the static phase operations 780, security hygiene procedures 750 may be performed before launching a cluster-aware deployment 760 of a workload. Here, security hygiene procedures 750 may be performed out of the execution loop as an initial first operation, or as part of a static phase (e.g., when any new workload arrives) for handling security intents 706. The security hygiene procedures 750 may include performing CVE scanning/mitigation, system re-configuration, container validation and evaluation, and other security configuration and validation practices. The security hygiene procedures 750 may be implemented with additional software security tools (not shown), including tools that scan with reference to a software bill of materials (BOM), which check for execution with root privileges, or which lock down some process or workload. The security hygiene procedures 750 may also interact with policies and utilize container orchestration tools such as Kyverno™ and the Open Policy Agent (OPA) Gatekeeper.

The static phase operations 780 thus may implement one or more aspects of CVE scanning/mitigation or container configuration, directly based on the security intents 706. Additionally, an orchestrator can determine and consider the high-level intents 704 specified for the workload 702 in relation to a particular orchestrated node or cluster. Based on the intent specifications, scheduling of the workload 702 may fail if hardware or software capabilities are lacking in the cluster. For example, if the user has specified high confidentiality (e.g., an intent of “confidentiality: high” in the intent definition), this intent can translate into launching the workload 702 in a hardware-enabled trusted execution environment or confidential computing platform. In further examples, if the workload 702 is unable to be scheduled in a particular cluster, the workload 702 may be launched in another cluster- or the current cluster may be enhanced with nodes with additional capability for the security requirements.

The use of security intents 706 thus provides an additional specification of execution features to ensure appropriate security actions are performed. Within the node, the high-level security intent is translated into low-level security actions, to address the whole set of high-level requirements. Thus, in contrast to the use of individual security tools, the security intents 706 can be used to invoke a series of tools and actions—on demand—that operationalize and apply an overall security policy for workload execution. This can help ensure that a specified security model will correctly apply to the specific workload execution.

The dynamic phase operations 740 involves monitoring workloads for any new vulnerabilities and taking action (such as when triggered by a new CVE detection), with the security risk monitoring 730. Potential actions that may be performed in the dynamic phase operations 740 may include: cordoning off (e.g., isolating, removing) a node, migrating workloads, or patching a node. Actions taken on the workload 702 may include stopping the workload 702, auto-updating the workload 702, or migrating the workload 702 to another node or cluster for isolation or confidentiality. The dynamic phase 740 may also include the exploration of plans 710, and execution of a base plan (the best plan 720), as discussed with reference to FIG. 7A, above.

The use of security intents 706 may allow the specification of multiple aspects for any specific security property, goal, or objective. In the context of intent-driven orchestration for cloud-native workloads, there may be multiple definitions of intents for more than one aspect of latency (such as median and tail); similarly, there may be multiple dimensions of intents for more than one aspect of security or some security intent property (such as confidentiality, integrity, isolation, etc.). Other aspects of cost, performance, and power can also be weighed and evaluated in connection with the security intents 706.

FIG. 8 depicts further characteristics and definition formats of security intents, as expressed in an example Docker compose file format 810. The security intent may be provided in an input file such as Helm Chart, Docker compose file, or Docker file, consistent with cloud native practices of providing workload launch information in such input files.

As depicted in FIG. 8, the security intent characteristics may include properties such as: Confidentiality 811; Integrity 812; Isolation 813; Auditability 814; and Infrastructure Risk 815. Other security intent characteristics not depicted may include: Immutability; Access (e.g., to Disable Admin access); or Networking (e.g., to implement a specific firewall or network isolation model). Other requirements or expressed properties may also be provided in a security intent definition.

In an example, static customer-mandated security intents are to be satisfied at launch time. Modifiers of the security intents (e.g., defined values such as high, medium, low, numeric values in a range, etc.) guide the implementation that is desired, with the choice being one that meets or exceeds the stated requirements. For example, logging provides auditability but remote logging provides even greater security—because if the original workload is compromised, it is harder to tamper with remote logs and cripple forensic analysis. Thus, a security intent may specify not only that logging is mandated, but also the type of logging, and the amount of logging.

The security intents primitives can be extended as needed. The purpose in having primitives is to mix and match according to the needs of the workload application. For instance, particular use cases of workloads involving Health Care, Finance, Human Resources, and Machine Learning applications may specify multiple types of security intent primitives. In other situations, for example during development and/or testing, a lower level of security may suffice, and thus fewer security intent primitives may be specified.

Thus, a significant technical advantage of high-level security intents is that the intents serve as a short-hand “template” for security recipes, while being agnostic about the platform details, software services, and the software stack in place. The set of primitives supported in the security intents can be expressed or made available to users via an API, documentation. In some no-code/low-code development environments, the set of primitives in the security intents can be made available in drop-down menus or as annotations and decorations in a user interface. In some examples, the output of such tools may be a Helm Chart or a Docker compose file with markings (e.g., as illustrated in connection with the Docker compose file format 810 in FIG. 8). In other examples, output may accompany the publishing of a container images to private or public container registries, along with an optional signature, software bill of materials (SBOMs), encryption keys, and more.

When security intents are provided with an incoming request, such requests can provide a specific designation associated with security attributes such as “confidentiality” and “auditability”. These designations can include high level tags for each attribute, and specific attribute values or value ranges. Some examples of attributes provided in the security intents are shown as follows with reference to FIG. 8:

Confidentiality 811 (e.g., a required level or type of confidentiality needed for the workload and the workload data); Integrity 812 (e.g., a required level or type of integrity checks or verification to be performed on the workload or on software (including dependencies) used to execute the workload); and Isolation 813 (e.g., a required level or type of isolation needed for execution of the workload). In an example, security isolation may be implemented with a container runtime such as Confidential Containers to create a confidential VM on-the-fly using confidential computing technologies. The use a confidential VM can also provide integrity and isolation. However, if confidentiality is not requested but just isolation, a workload may be launched in a classic VM/or lightweight VM (e.g., kata-container) to provide address space or network isolation.

Auditability 814 (e.g., a required type or result of auditable data in connection with the workload and the workload data). This may include use of a Service Mesh that provides a sidecar or other component (for example, an Ambient Service Mesh) that provides logging capabilities. With a “high” value specified for auditability, the logging can be remotely provided, such as on a backing datastore with replication. With a “low” value specified for auditability, the logging can be provided to a local disk.

Infrastructure Risk 815 (e.g., a sensitivity of infrastructure use or interaction with the workload and the workload data). This may include assessing and reducing a node-level risk from respective OS/hypervisor CVEs. This may also include placement of a node into “maintenance mode” to drain it of its current workloads and migrate them to a non-vulnerable node (e.g. one that was patched earlier), and then patching the current node before pressing it back into service. A CVE such as a Linux kernel vulnerability may invoke this sequence of actions.

Other types of security intents may be related to other aspects of: Auditability; Confidentiality; Integrity; Isolation; Immutability; Administrative Access; Networking Capabilities (firewall); and the like. The values defined by the security intents can be qualitative, quantitative, or relating to categorial intents and associated objectives. Examples of categorial intents might include category values such as “high”, “medium”, “low” or “gold”, “silver”, “bronze”. Examples of qualitative intents might include requirements such as specifications for the use of multiple workload accelerators (e.g., Intel® Quick Assist Technology accelerators). Examples of quantitative intents might include requirements such as, accepting a risk factor of 0.5.

TABLE 1, below, defines an example of multiple security intents and a pod specification with the security intents, for an example deployment in Kubernetes.

TABLE 1

```
---
apiVersion: v1alpha1
kind: SecurityIntents
metadata:
  name: untrusted-infra
spec:
  confidentiality:
    compute: high
    network: high
---
apiVersion: v1alpha1
kind: SecurityIntents
metadata:
  name: untrusted-workloads
spec:
  isolation:
    compute: medium
  vulnerability:
    maxCvssScore: 9.0
    pollPeriod: “10s”
---
apiVersion: v1
kind: Pod
metadata:
  labels:
    security-intents.domain.com/name: untrusted-infra
  name: user-pod
spec:
  # . . .
---
apiVersion: v1
kind: Namespace
metadata:
  labels:
    security-intents.domain.com/name: untrusted-workloads
  name: tenant
```

The handling of security intents may involve the use of static and dynamic aspects, as discussed with reference to FIG. 7B above. Occasionally multiple actions are combined to achieve a high level intent while in other cases there are multiple options. In the latter case, if there are additional Key Performance Indicators (KPIs) specified as a lowest cost, such KPIs may be factored in to make a selection.

In addition to dynamic changes or adjustment of a platform, other aspects of handling security intents may include disabling access or capabilities. For example, a lock down of system access may be implemented using a runtime that prevents any execution access via admin credentials into a container. In other examples, alerting may be used to handle security intents. This may include alerting an end-user about a workload's vulnerabilities and potentially launching it in a lightweight VM such as a Kata-container (a classic VM wrapped container to obtain address space isolation and sandboxing). Other types of alerts might be used to notify a workload owner if a reported CVE has a patch to recommend updating and re-launching; whereas a workload with a high severity CVE might notify a workload owner before stopping execution. In some examples, alerting might be accompanied by no action taken (such as when a CVE infested workload does not affect other workloads running on the same node, if all of the other workloads are running in TEEs).

A further example of adaptation in response to security intents may involve supporting key creation and protection approaches in a TEE to secure communications. Running a workload in a Trusted Execution Environment (TEE) may protect the workload from other workloads sharing the infrastructure, but the workload still needs network security to be protected from denial of service attacks, and attestation to ensure that the correct workload state is running as expected. However, even a TEE-protected workload can be malicious and launch attacks on other workloads, so even a TEE-protected workload needs to plug vulnerabilities and have appropriate network security measures in place.

In further examples, the use of security intents may be coordinated with Security Risk Scoring. Scoring may be initiated by ensuring basic levels of security hygiene, starting at an initial security risk score of 0. In this context, security hygiene refers to the security best practices (e.g., recommendations defined by NIST, CIS Bench and others) that address vulnerabilities in the workloads based on their software bill of materials, launching containers with the least privileges necessary, not running a workload as root, among other examples. Occasionally a workload needs certain elevated privileges in which case a high base risk score can be assigned to the same. The system may adjust the security risk score if all high-level security intents for a workload cannot be honored. Per configured security policy a workload risk score may render it unfit to launch or will be launched with warnings. The system may also assign a security risk score stemming from an individual workload to other workloads sharing the infrastructure. The goal is to capture the blast radius of a vulnerability. Some vulnerabilities may affect workloads running on the same node while others may hurt the whole cluster and beyond if the resources can be used to launch a denial of service attack across the internet.

The attack potential of an individual vulnerability in a workload or one of its dependencies may be considered in some examples, although the examples above are focused on a node level security risk. If a workload is the sole occupant of a node, the risk might be tolerable but as more workloads share the node, the risk rises O(N) where N are the number of workloads with regulated industry workloads weighting the risk contribution higher. Accordingly, a node level security risk score may be provided from a sum of the contributions of each of the individual workload vulnerabilities.

In further examples, monitoring is performed with the use of a monitoring component. The monitoring component periodically checks to determine if any new vulnerabilities have been reported that affects the running workloads. In the event of a new CVE, the security risk score is recomputed for the host node using the function: (sum-CVE-severity-core*number of co-resident workloads) and for the individual affected workloads.

One or more actions as mentioned above are evaluated for best strategy per configured security policies. The general rule of thumb is when more workloads are sharing the infrastructure it is more important to address the vulnerabilities via patching when fixes are available or by using other mitigation mechanisms (such as firewall rules, eBPF (extended Berkeley Packet Filter) security tools, or migrating a high value workload to another node or into a confidential virtual machine) to reduce security risk. A node-level software CVE can be addressed with a maintenance mode to the node as discussed above.

The use of security intents may be combined with the use of a variety of other security tools and frameworks. As will be understood, a variety of security tools can be used to scan for Software bill of materials, to inspect for the execution of software root privileges, or to implement lock-down measures for security. These tools, by themselves, often only address one limited aspect of security, and do not make it easy to address other concerns (such as to guarantee confidentiality). The use of security intents with these tools, in contrast, provides an improved way to operationalize security and apply a policy to make the correct tool address the correct security concern.

As an example, security intents may be used with a built-in container Pod Security admission controller, such as that provided by Kubernetes. This controller can validate created Pods against one of three security policies and admits, warns, or rejects the creation of the Pod.

As an example, security intents may be used by Grype™, Trivy™, and other vulnerability scanning tools that scan a Software Bill of Materials to determine if there exist any known vulnerabilities against them and how severe they are, and whether there exist patches for the same.

As another example, security intents may be used by Kubescape™. This tool scans Kubernetes resources for risks, assigns a risk score (0 to 100) to each examined risk, and suggests remediations (configuration changes) to address risk.

As another example, security intents may be used by Open Policy Agent (OPA) Gatekeeper. Gatekeeper uses an OPA constraint framework to describe and enforce policies. Gatekeeper also supports mutation with mutation Custom Resource Descriptors.

As another example, security intents may be used by Kyverno™. Like OPA Gatekeeper, Kyverno™ can validate and mutate configurations using admission controls and background scans. It can also generate configuration data.

As another example, security intents may be used with intent-based network security implemented in hardware components. One example is the use of intent-based network security in Cisco® networking hardware, although other networking implementations are also possible.

The use of security intents provides enhancements over the basic use of these tools. While some Kubernetes tools (Kubescape™, OPA Gatekeeper™, Kyverno™ and others) listed above check for CVEs, configuration errors, and access policies, they do not quantify the risk to other workloads running on shared infrastructure, nor do they address heterogeneity in hardware across clusters cloud to edge. Likewise, while intent-based network security approaches can improve the use of network security through networking hardware improvements, such processing is complementary to protect the actual workloads and infrastructure, the ingress/egress point of network packets.

The use of security intents as discussed above may be used in combination with aspects of confidential computing platforms (e.g., including but not limited to Intel® Trust Domain Extensions (TDX), Intel® Software Guard Extensions (SGX), ARM® TrustZone, AMD® Secure Encrypted Virtualization (SEV)). This enables running even regulated industry workloads on shared infrastructure to realize cost savings, lower latency, and higher availability.

Accordingly, these approaches with security intents provide a way for assessing and handling a methodical security risk-based addressing of high-level security intents. The use of security intents can free the end user of needing deep hardware and software knowledge to protect workloads, while enabling flexible deployments and improved system operations. Other technical advantages and benefits will also be apparent, including in combination with the following trust coordination operations.

### Trust Coordination Across Computing Elements in a Cloud to Edge Continuum

Distributed compute and networking have evolved into a hyper-connected compute continuum with the introduction of various C2E approaches. C2E approaches are expected to be adopted by many industry participants, including cloud service providers (CSPs), communications service providers (CoSPs), and enterprise providers. C2E approaches enable the transition from vertically integrated, industry-specific solutions to horizontal platforms where all compute nodes can execute workloads, produce, and consume data.

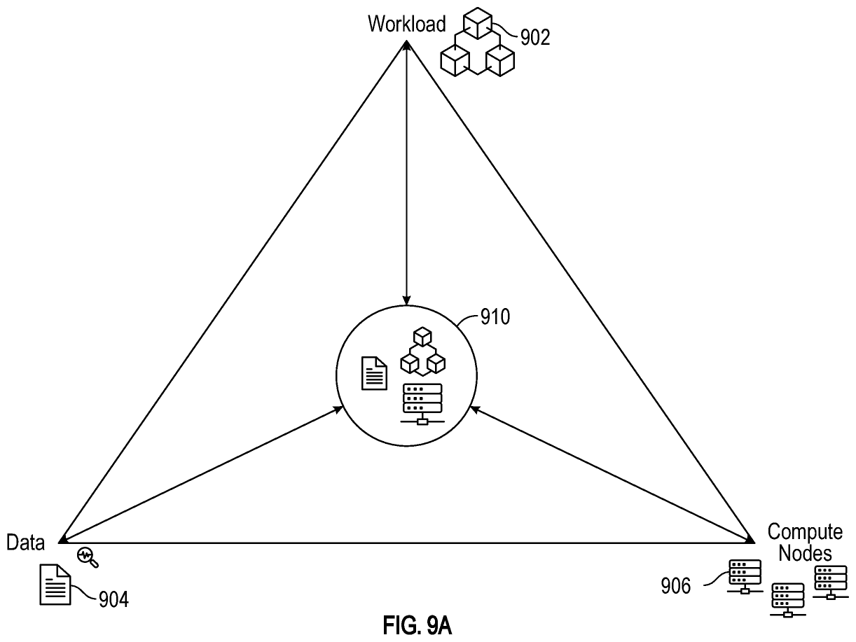

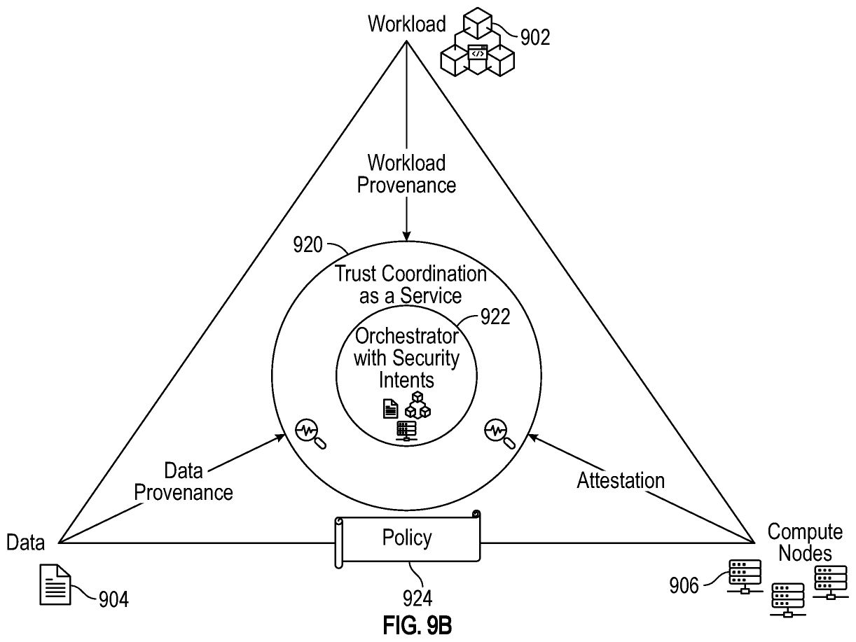

FIG. 9A is a diagram illustrating the elements of a hyperconnected compute continuum, according to an example. Three elements primarily participate in the hyper-connected compute continuum: workloads 902, data 904, and compute nodes 906. Security is a key contributing factor for workload elasticity in C2E deployments 910 that use these elements, to ensure the capability to move workloads across the different end points of execution. Industry participants may have the view that unreliable security hinders C2E operations. Security requirements cannot be addressed without establishing trust between the elements of the compute continuum. Protecting edge components with intrinsic security of applications, data and infrastructure is also a concern. This complex technical problem, driven by multi-party supply chains and customer interactions, also needs to be scalable.

Some attempts for trust establishment have used siloed, vertical attestation for a compute node or workload (e.g., siloed uses of Intel® SGX attestation, Secure Boot using Trusted Platform Module (TPM), DICE, or SPIRE). Accordingly, Data Provenance attestation may not be used or might be limited to per-app or per-microservice implementations. For example, consider the use of OPA (Open Policy Agent), which is an open source, general-purpose policy engine that unifies policy enforcement across a software stack. It provides a high-level declarative language to specify policy as code and APIs to offload policy decision-making, but does not necessarily perform aggregation of the assertions or include an ability to reassess the assertions (metadata) at runtime.

Other issues and challenges may arise in some Cloud-to-Edge and elastic workload approaches for trust establishment. For instance, implementations follow needs, which may create lag in deployments. Further, there is fragmentation and redundancy among many approaches, resulting in failure-prone implementations. There are also implementation inefficiencies, such as hard-coded policies, which are difficult to maintain. Thus, some implementations can have a lack of consistency, use an ad-hoc format, are standard-adverse, are difficult to scale (being embedded in other code/product), and are difficult to secure (and if they are embedded, they may need additional technical solutions).

The following addresses further aspects of multi-party trust coordination, to provide trustworthiness from the exchange of metadata, evaluation of metadata per policies, and decision making. This trust coordination is applicable to complex C2E compute environments that enable multiple parties to provide heterogeneous metadata and associated policies and entity capabilities. Further, the following also provides approaches to collect, analyze, make decisions, and reassess the trustworthiness assertion based on policies and entity capabilities.

Compared to a singular attestation approach, the following trust coordination implementation will enable specific requirements of entities such as devices, workloads, or data instances to support assertion policies. For example, the trust coordination implementation can introduce new methods, protocols and interfaces for registration, and the exchange and query of assertions and for registration and evaluation of policies (e.g., APIs available to the edge and cloud customers to specify or select an attestation policy when they want to run a sensitive workload in the cloud that requires protection from software and hardware exploits).

FIG. 9B illustrates the use of a trust coordination as a service, according to an example. This implementation demonstrates trust coordination across heterogenous elements of computing in an C2E framework. Trust Coordination Framework (TCF) can be an implementation that can be presented as a Trust Coordination-as-a-Service (TCaaS) engine 920 integrated into Cloud-to-Edge Orchestration Solutions. Here, the workload 902 can be associated with workload provenance characteristics; the data 904 can be associated with data provenance characteristics; and the compute nodes 906 can be associated with attestation values. The TCaaS engine 920 may be operated or used by an orchestrator 922, to consider security intents and other aspects of a policy 924.

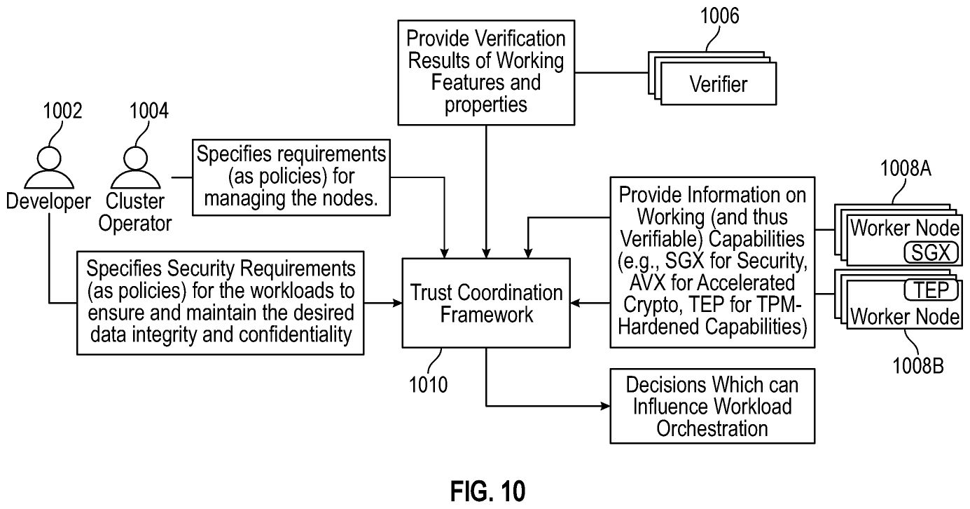

FIG. 10 is a diagram illustrating trust coordination, according to an example. As observed by reviewing FIG. 10, there are many problems and challenges in solving trust coordination. A developer 1002 may specify security requirements (in policies) for workloads, whereas a cluster operator 1004 may specify requirements (in policies) for managing nodes that operate the workload, including the requirements provided based on the security intents discussed above. Multiple policies contribute metadata relating to security (e.g., relating to the policies, requirements, working capabilities, and software properties). However, this metadata is often heterogeneous (e.g., is not bound to a particular software or hardware technology). Additionally, a verifier 1006 may be invoked to obtain verification results of working features and properties. Additionally, a worker node 1008A or 1008B may use different technologies and provide information on working (and thus verifiable) capabilities.

Systems and methods described herein provide for trust coordination across heterogenous elements in an C2E setting, with use of a trust coordination framework 1010. This framework 1010 provides a mechanism for processing of heterogeneous multi-party metadata that includes collection, analysis (reasoning) and dynamic reassessment of policies over metadata. The framework 1010 simplifies evaluation of relevant metadata and policy management, and makes or assists decisions that influence workload orchestration. The framework 1010 relieves reliant services (e.g., dependent services) from the complexity of handling metadata and policies (in terms of quantity, size, and heterogeneity), such as by SGX attestations, TPM attestations (like in Keylime), software supply chain assertions, data provenance assertions, etc. The framework 1010 also consolidates metadata and policy handling in a single instance for multiple relying services. The framework 1010 also minimizes code maintenance of relying services to update metadata formats and policies.

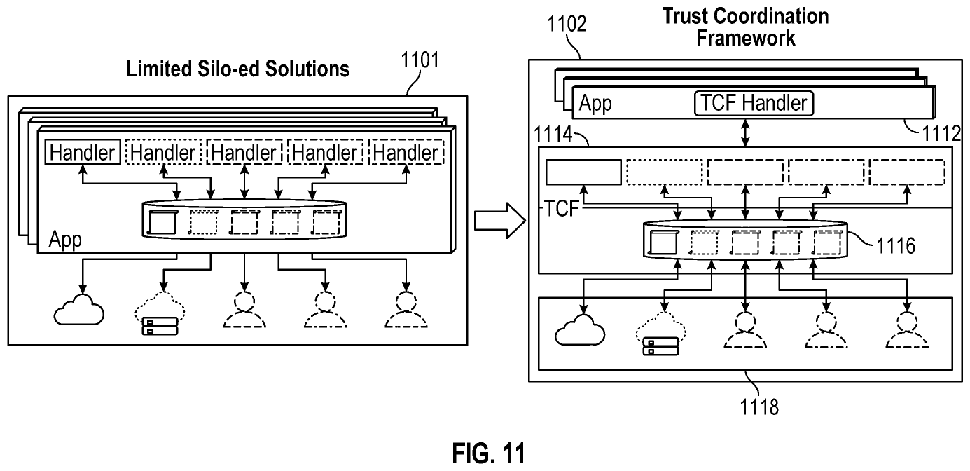

FIG. 11 illustrates existing siloed approaches as contrasted with an advancement to a trust coordination framework (TCF), according to an example. Current deployments 1101 use metadata collection and analysis on a per-app (per-microservice) basis, and are typically not scalable while being difficult to build and maintain. In contrast, a TCF 1102 acts as an active intermediary to establish trustworthiness based on verifiable information across compute nodes, workloads, and data. The TCF 1102 separates metadata collection, handling, and policy management from apps/microservices 1112. The TCF 1102 provides a single framework for multiple deployment scenarios 1114. The TCF 1102 allows reuse of metadata, handlers, and policies 1116 and enables policy decisions over heterogeneous metadata/technologies and users 1118.

The TCF 1102 simplifies metadata and policy management by relieving “relying” services (e.g., dependent services) from the complexity of handling metadata and policies—in terms of quantity, size, and heterogeneity. For instance, the relying services may include Intel® SGX, Intel® TDX, DICE or TPM attestations (or attestations from a similar secure environment), software supply chain assertions, data provenance assertions, etc. Use of the TCF 1102 also consolidates metadata and policy handling in a single instance for multiple relying services and avoids code maintenance of relying services to update metadata formats and policies.

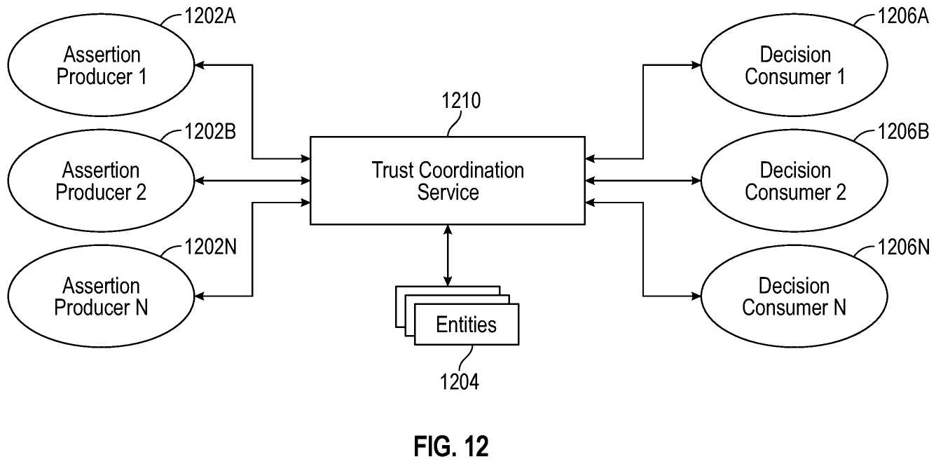

FIG. 12 is a diagram illustrating interoperability of a trust coordination service, according to an example. Trust coordination in this scenario includes the following Actors: assertion producers 1202A, 1202B, . . . 1202N, which produces assertion related to the entity capabilities, platform properties, and/or verification results (e.g., related to hardware-based attestations, SW properties, etc.); decision consumers 1206A, 1206B, . . . 1206N, which consumes a policy trustworthiness decision per requested entity; Entities 1204, which are the subject for trustworthiness that present attributes of trustworthiness; and a trust coordination service 1210, which aggregates the metadata and makes decisions based on provided policies.

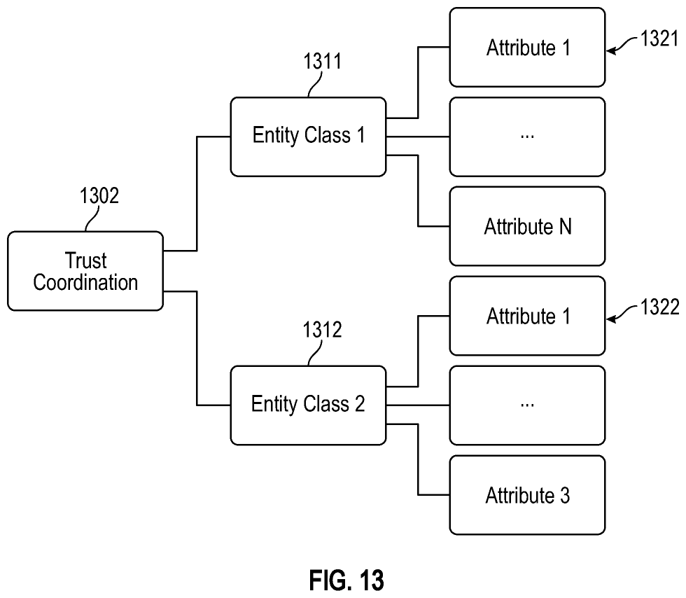

FIG. 13 is a block diagram illustrating a general hierarchy of classes and attributes, according to an example. A respective component of the compute continuum can associate trust coordination 1302 with several entity classes (e.g., 1311, 1312). A respective entity class may have associated trustworthiness attributes (e.g., 1321, 1322), such as attestation, provenance, a Software Bill of Material (SBOM) assertion, safety, resiliency, etc.

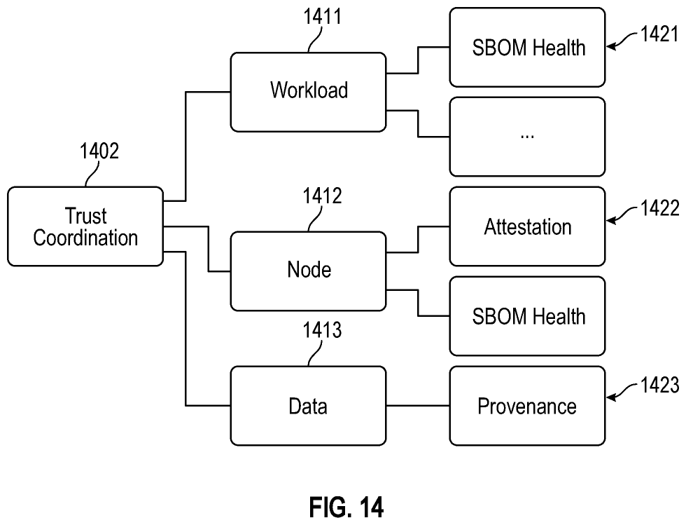

FIG. 14 is a block diagram illustrating a specific hierarchy of classes and attributes, according to an example. Here, there are three classes that are illustrated for trust coordination 1402: workload 1411, associated with attributes 1421 for native workload or containers; node 1412, associated with attributes 1422 for compute resources; and data 1413, associated with provenance attributes 1423 for structured or unstructured data that is generated or consumed.

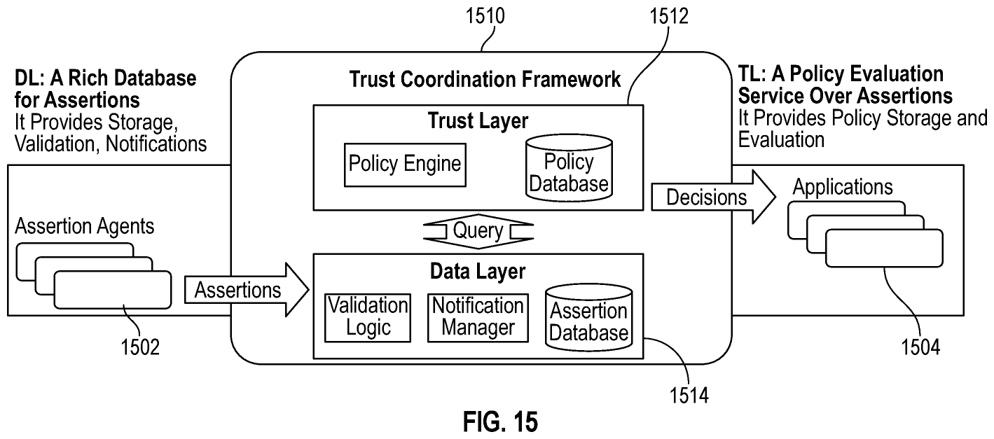

FIG. 15 is a block diagram illustrating a trust coordination framework architecture, according to an example. An embodiment of a trust coordination framework 1510 illustrated in FIG. 15 includes two layers. A data layer 1512 is responsible for the assertion validation, collection, storage, and notification. A trust layer 1514 contains a policy engine and provides policy storage and evaluation services. Assertion agents 1502 feed assertions to the data layer. Such assertions are signed for accountability and integrity. The trust layer finally provides policy decisions (evaluated over the assertions in the data layer) to applications 1504 (or relying parties).

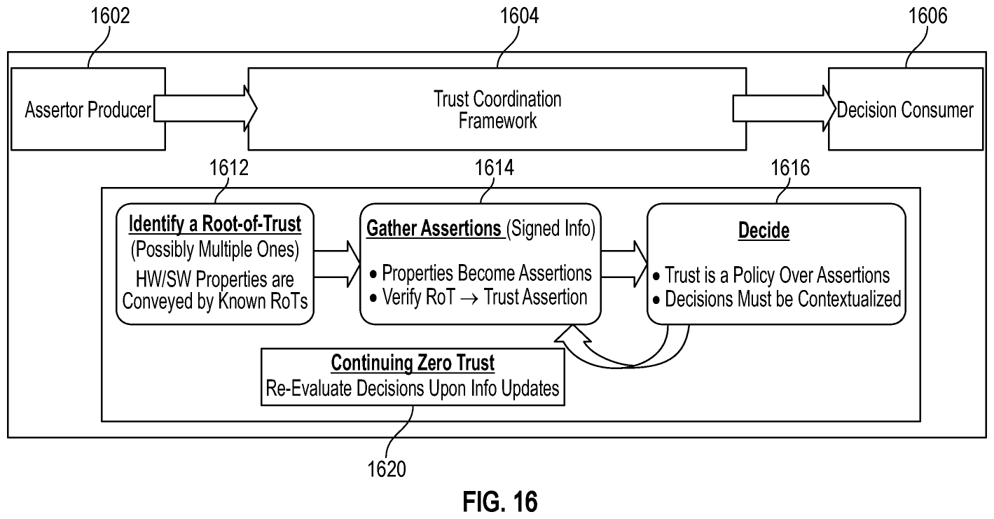

FIG. 16 is a block diagram illustrating high-level operations in a trust coordination framework architecture, according to an example. These operations are coordinated among an assertor producer 1602, providing information to a trust coordination framework 1604 for evaluation, which then provides decision information to a decision consumer 1606.

The high-level operations are used to assess the trustworthiness of platforms, software, or workloads. First, the necessary Root-of-Trusts (RoTs) are defined at operation 1612. The RoTs will convey (or will certify other parties who will convey) software and/or hardware features and properties. Second, assertions are collected at operation 1614. Finally, a policy is evaluated at operation 1616 to determine a decision. As the context changes (e.g., new assertions are collected, or previous assertions are updated), policies are (or can be) re-evaluated at operation 1620 to confirm previous decisions, or to trigger contingency actions. In further examples, open-source solutions such as Open Policy Agent (OPA) or another policy engine can be used for policy specification and evaluation.

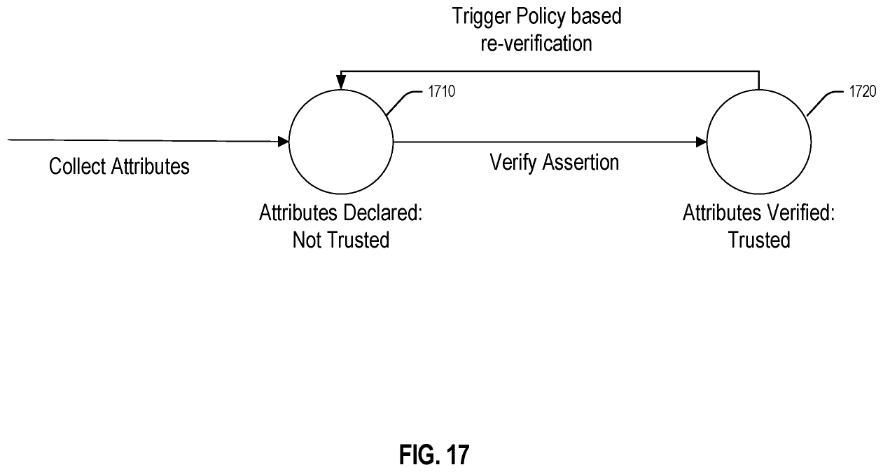

FIG. 17 is a block diagram illustrating state transitions of trustworthiness attributes, according to an example. Attributes transition from a non-trusted state 1710 to a trusted state 1720, based on verifying a declared attribute assertion. Subsequent re-verification may be used which triggers a policy. (In practice, the attributes may be continually in a trusted state, but the relying party that is modeling attribute trust may maintain a distinct or separate attribute state machine that models the attribute state transition as a way to achieve trust consistency over a distributed set of nodes).

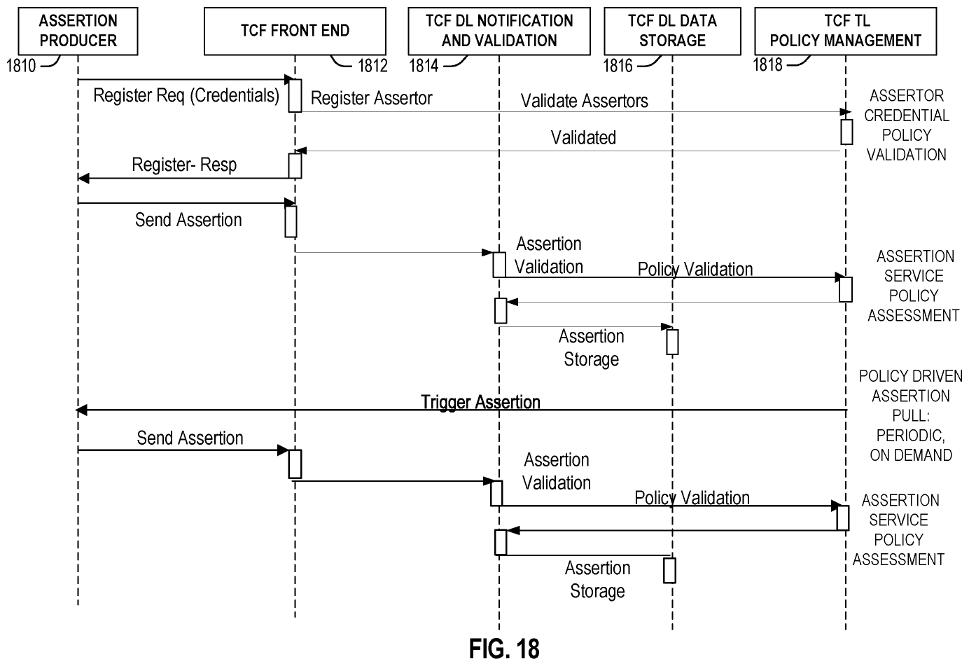

FIGS. 18-20 are swim lane diagrams illustrating interactions between respective components of a trust coordination framework architecture, according to various examples.

In FIG. 18, an assertion producer 1810 provides a request to a trust coordination framework front end 1812. The trust coordination framework data layer (DL) provides notification and validation functions 1814 and data storage functions 2816, whereas the trust coordination framework trust layer (TL) provides policy management functions 1818.

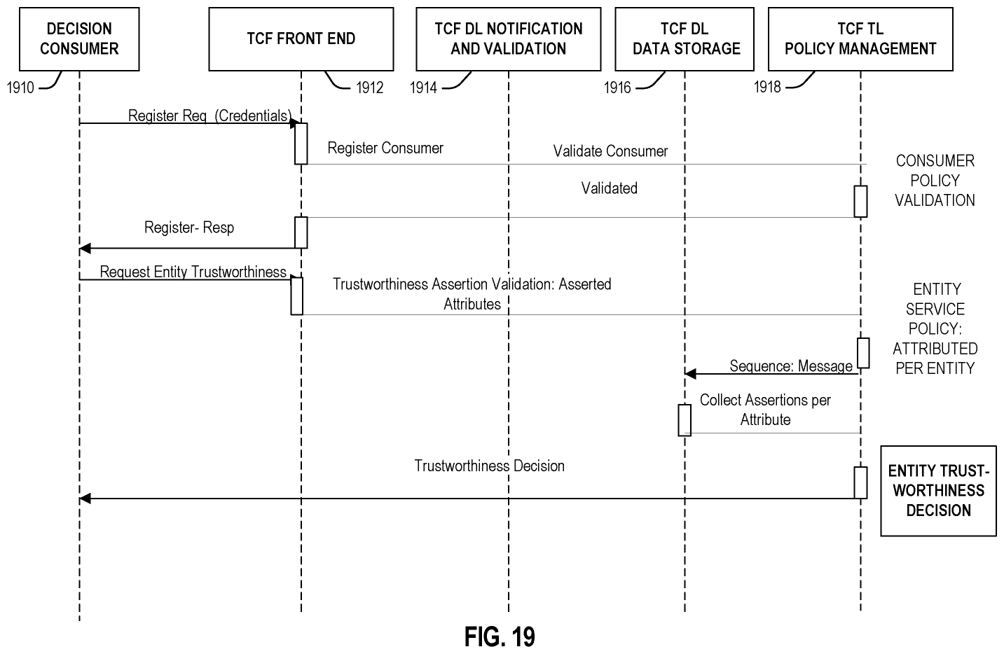

In FIG. 19, a decision consumer 1910 provides a request to a trust coordination framework front end 1912. The trust coordination framework data layer (DL) provides notification and validation functions 1914 and data storage functions 1916, whereas the trust coordination framework trust layer (TL) provides policy management functions 1918.

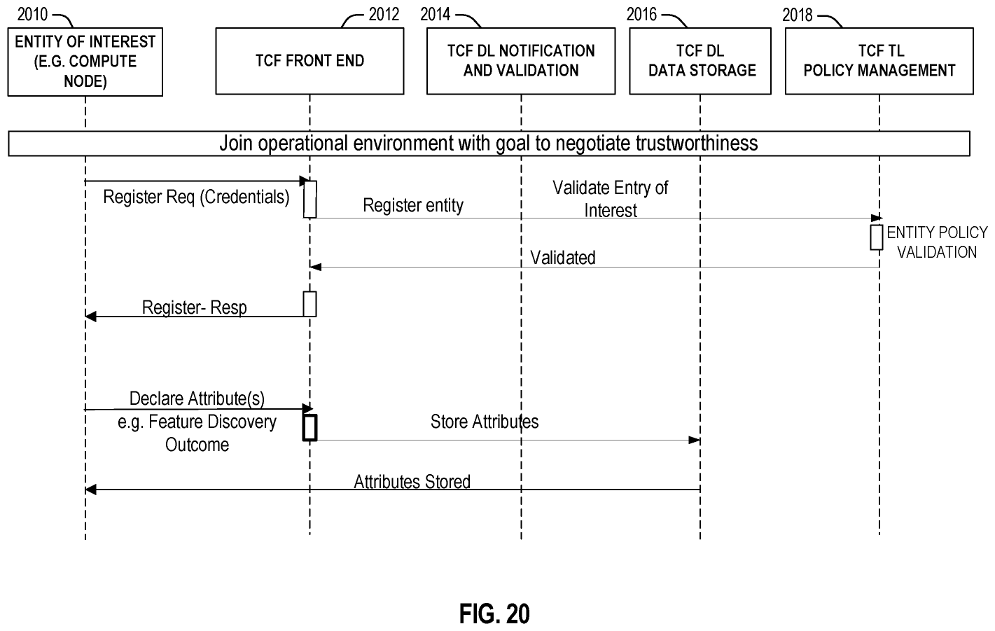

In FIG. 20, an entity of interest 2010 (such as a compute node) communicates with a trust coordination framework front end 2012 to join the operational environment. The trust coordination framework data layer (DL) provides notification and validation functions 2014 and data storage functions 2016, whereas the trust coordination framework trust layer (TL) provides policy management functions 2018.

### Implementation Examples

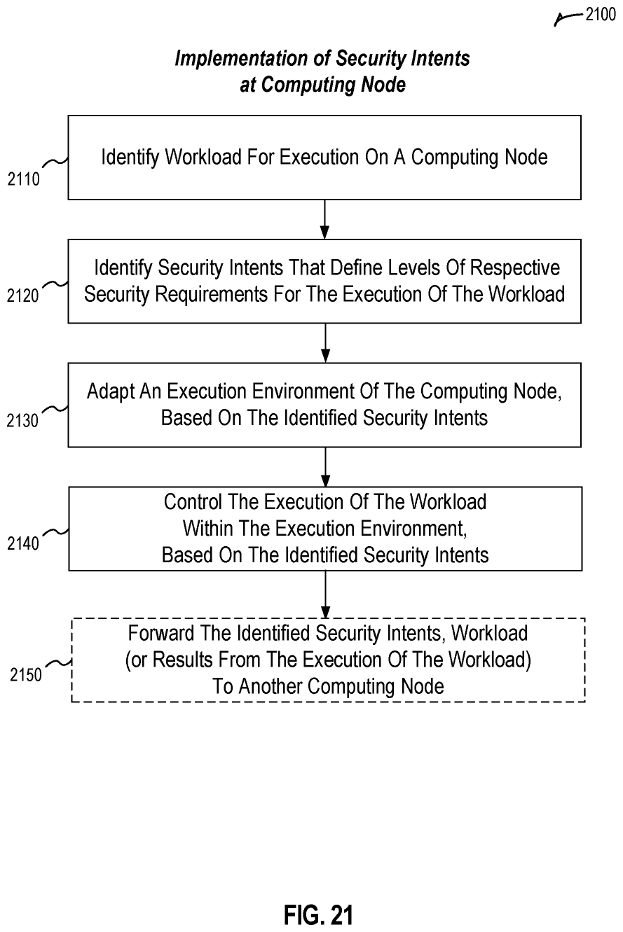

FIG. 21 is a flowchart illustrating operations for implementing security intents at a computing node, for coordinating execution of cloud-native or cloud-to-edge workloads, according to an example. In some examples, these operations may be optionally performed, performed in another order, or repeated based on the examples provided above. The operations may be performed by or coordinated by a computing node, edge/cloud node, orchestrator, or other computing devices here with reference to the examples provided above.

Operation 2110 includes identifying a workload for execution on a computing node. This workload may include the elastic and cloud-native workloads discussed above, including workloads that provide one or more applications that execute inside of containers. However, in other examples, the workload may be executed independently of a container architecture.

Operation 2120 includes identifying security intents that define levels of respective security requirements for the execution of the workload. In an example, the security intents define properties related to least one of the following requirements: confidentiality, integrity, isolation, audibility, and infrastructure. Such properties can correspond to respective numeric value ranges or pre-defined values for the security intents. In a specific example, the security intents are provided within a Helm Chart or a Docker compose file associated with a container image used to execute the workload.

Operation 2130 includes adapting an execution environment of the computing node, based on the identified security intents. In this context, adapting the execution may include creating a new execution environment or modifying an existing execution environment, for use on the compute node. In an example, this execution environment is a software execution environment that includes a container, a virtual machine, or an operating system. Other aspects of an associated hardware execution environment (e.g., that enables the software execution environment) may also be adapted, including hardware-based partitions or slices. In specific examples, operations to adapt the execution environment include to: isolate the execution environment on the computing node; migrate the workload to another computing node; or perform a security update to the execution environment. For instance, isolating the execution environment may include use of a trusted/secure execution environment, instantiating a new secure execution environment, separating the execution environment from other workloads (including migrating other workloads onto different nodes), and other types of virtualization and security isolation techniques.

Operation 2140 includes controlling the execution of the workload within the execution environment, based on the identified security intents. This may include the use of security hygiene as discussed above. For instance, security hygiene may include perform ongoing scanning of the execution environment and the workload to identify common vulnerabilities and exposures (CVEs). Then, operations to adapt the execution environment can be performed based on a remedial action in response to the identified CVEs. In still further examples, controlling the execution of the workload may include monitoring the execution of the workload with a trust coordination framework, as discussed above. This can enable detection of real-time/dynamic changes and security conditions that might not be immediately detected.

In an example, the operations to adapt the execution environment and control the execution of the workload are based on use of a security policy provided from a plurality of security policies, such as security policies coordinated by the trust coordination framework. This can assist in a scenario where the computing node is one of a plurality of computing nodes in a cluster, and the security policy is applicable to multiple (or all) of the plurality of computing nodes.

Operation 2150 includes, optionally, forwarding the identified security intents and the workload (or results from the execution of the workload) to another computing node. For example, an improved security environment may be available on the another computing node. The operations to forward may include determining a selected node of the plurality of computing nodes in the cluster; forwarding the identified security intents to the selected node; and forwarding the workload or results from the execution of the workload to the selected node.

Additional operations for execution and verification of elastic workloads (and security measures for handling such elastic workloads) may be performed as discussed in the various examples above. Additional operations may also be provided based on the hardware environment used to execute the workload. For instance, a particular computing node may implement the operations 2110-2150 via processing circuitry that is configured to execute the workload (and related software instructions). The processing circuitry may include at least one central processing unit (CPU), graphics processing unit (GPU), or accelerator, consistent with the examples herein. In further examples, other hardware and virtualization techniques may be implemented on the processing circuitry in connection with the operations 2110-2150, including Single Root I/O Virtualization (SR-IOV) and Scaleable I/O Virtualization (Scaleable IOV), which uses isolation and virtualization to assign and manage particular hardware resources.

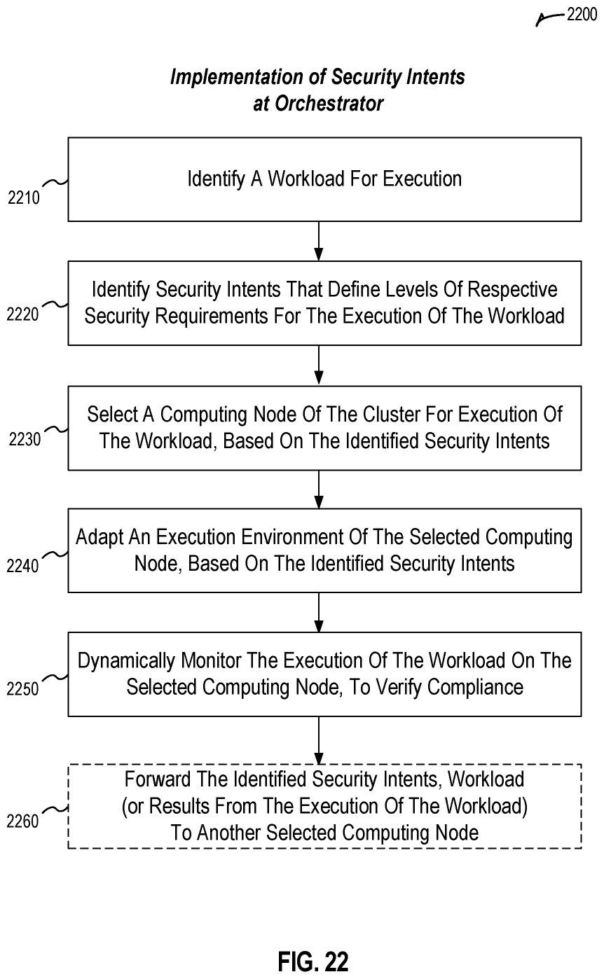

FIG. 22 is a flowchart illustrating operations for implementing security intents at an orchestrator of a compute cluster, for coordinating execution of cloud-native or cloud-to-edge workloads among one or multiple computing nodes in a cluster (or a pod), according to an example. In some examples, these operations may be optionally performed, performed in another order, or repeated based on the examples provided above.

Operation 2210 includes identifying a workload for execution. This may implement the operations discussed in operation 2110, above.

Operation 2220 includes identifying security intents that define levels of respective security requirements for the execution of the workload. This may implement the operations discussed in operation 2120, above.

Operation 2230 includes selecting a computing node of the cluster for execution of the workload, based on the identified security intents. Here, the orchestrator may use the security intents information to directly coordinate and control the initial and subsequent execution of the workload (including coordination with multiple workloads in the system).

Operation 2240 includes adapting an execution environment of the selected computing node, based on the identified security intents. This may implement the operations discussed in operation 2130, above, as performed by an orchestrator.

Operation 2250 includes dynamically monitoring the execution of the workload on the selected computing node, to verify compliance. This may implement the operations discussed in operation 2140, above, as performed by an orchestrator.

Operation 2260 includes optionally, forwarding the identified security intents and the workload (or results from the execution of the workload) to another selected computing node. This may implement the operations discussed in operation 2150, above, as performed by an orchestrator.

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example 1 is a computing node configured to implement security intents for a workload, comprising: processing circuitry; and a memory device including instructions embodied thereon, wherein the instructions, which when executed by the processing circuitry, configure the processing circuitry to cause operations that: identify a workload for execution on the computing node; identify security intents that define levels of respective security requirements for the execution of the workload on the computing node; adapt an execution environment of the computing node, based on the identified security intents; and control the execution of the workload within the execution environment, based on the identified security intents, to dynamically monitor and adapt to changing security conditions during the execution of the workload.

In Example 2, the subject matter of Example 1 optionally includes wherein the execution environment includes a container, a virtual machine, or an operating system.

In Example 3, the subject matter of any one or more of Examples 1-2 optionally include wherein the operations to adapt the execution environment include to: isolate the execution environment on the computing node; migrate the workload to another computing node; or perform a security update to the execution environment.

In Example 4, the subject matter of any one or more of Examples 1-3 optionally include wherein the instructions further configure the processing circuitry to cause operations that: perform scanning of the execution environment and the workload to identify common vulnerabilities and exposures (CVEs); wherein the operations to adapt the execution environment are further based on a remedial action in response to the identified CVEs.

In Example 5, the subject matter of any one or more of Examples 1-4 optionally include wherein the security intents define properties related to least one of: confidentiality, integrity, isolation, audibility, and infrastructure, and wherein the properties correspond to respective numeric value ranges or pre-defined values for the security intents.

In Example 6, the subject matter of any one or more of Examples 1-5 optionally include wherein the security intents are provided within a Helm Chart or a Docker compose file associated with a container image used to execute the workload.

In Example 7, the subject matter of any one or more of Examples 1-6 optionally include wherein the instructions further configure the processing circuitry to cause operations that: monitor the execution of the workload with a trust coordination framework.

In Example 8, the subject matter of Example 7 optionally includes wherein the operations to adapt the execution environment and control the execution of the workload are based on use of a security policy provided from a plurality of security policies, wherein the computing node is one of a plurality of computing nodes in a cluster, and wherein the security policy is applicable to the plurality of computing nodes.

In Example 9, the subject matter of Example 8 optionally includes wherein the instructions further configure the processing circuitry to cause operations that: determine a selected node of the plurality of computing nodes in the cluster; forward the identified security intents to the selected node; and forward the workload or results from the execution of the workload to the selected node.

In Example 10, the subject matter of any one or more of Examples 1-9 optionally include wherein the processing circuitry is configured to execute the workload, and wherein the processing circuitry includes at least one central processing unit (CPU), graphics processing unit (GPU), or accelerator.

Example 11 is at least one non-transitory machine-readable storage medium comprising instructions stored thereupon, which when executed by processing circuitry of a computing node, cause the processing circuitry to: identify a workload for execution on the computing node; identify security intents that define levels of respective security requirements for the execution of the workload on the computing node; adapt an execution environment of the computing node, based on the identified security intents; and control the execution of the workload within the execution environment, based on the identified security intents, to dynamically monitor and adapt to changing security conditions during the execution of the workload.

In Example 12, the subject matter of Example 11 optionally includes wherein the execution environment includes a container, a virtual machine, or an operating system.

In Example 13, the subject matter of any one or more of Examples 11-12 optionally include wherein to adapt the execution environment includes to: isolate the execution environment on the computing node; migrate the workload to another computing node; or perform a security update to the execution environment.

In Example 14, the subject matter of any one or more of Examples 11-13 optionally include wherein the instructions further cause the processing circuitry to: perform scanning of the execution environment and the workload to identify common vulnerabilities and exposures (CVEs); wherein to adapt the execution environment is based on a remedial action in response to the identified CVEs.

In Example 15, the subject matter of any one or more of Examples 11-14 optionally include wherein the security intents define properties related to least one of: confidentiality, integrity, isolation, audibility, and infrastructure, and wherein the properties correspond to respective numeric value ranges or pre-defined values for the security intents.

In Example 16, the subject matter of any one or more of Examples 11-optionally include wherein the security intents are provided within a Helm Chart or a Docker compose file associated with a container image used to execute the workload.

In Example 17, the subject matter of any one or more of Examples 11-16 optionally include wherein the instructions further cause the processing circuitry to: monitor the execution of the workload with a trust coordination framework.

In Example 18, the subject matter of Example 17 optionally includes wherein to adapt the execution environment and control the execution of the workload are based on use of a security policy provided from a plurality of security policies, wherein the computing node is one of a plurality of computing nodes in a cluster, and wherein the security policy is applicable to the plurality of computing nodes.

In Example 19, the subject matter of Example 18 optionally includes wherein the instructions further cause the processing circuitry to: determine a selected node of the plurality of computing nodes in the cluster; forward the identified security intents to the selected node; and forward the workload or results from the execution of the workload to the selected node.

In Example 20, the subject matter of any one or more of Examples 11-19 optionally include wherein the processing circuitry is configured to execute the workload, and wherein the processing circuitry includes at least one central processing unit (CPU), graphics processing unit (GPU), or accelerator.

Example 21 is an orchestrator configured to implement security intents for execution of a workload in a cluster, comprising: processing circuitry; and a memory device including instructions embodied thereon, wherein the instructions, which when executed by the processing circuitry, configure the processing circuitry to cause operations that: identify a workload for execution; identify security intents that define levels of respective security requirements for the execution of the workload; select a computing node of the cluster for execution of the workload, based on the identified security intents; adapt an execution environment of the selected computing node, based on the identified security intents; and dynamically monitor the execution of the workload on the selected computing node, to verify compliance with the identified security intents in response to changed security conditions during the execution of the workload.

In Example 22, the subject matter of Example 21 optionally includes wherein the execution environment includes a container, a virtual machine, or an operating system.

In Example 23, the subject matter of any one or more of Examples 21-22 optionally include wherein the operations to adapt the execution environment include to: isolate the execution environment on the selected computing node; or perform a security update to the execution environment.

In Example 24, the subject matter of any one or more of Examples 21-23 optionally include wherein the instructions further configure the processing circuitry to cause operations that: perform scanning of the execution environment and the workload to identify common vulnerabilities and exposures (CVEs); wherein the operations to adapt the execution environment are further based on a remedial action in response to the identified CVEs.

In Example 25, the subject matter of any one or more of Examples 21-24 optionally include wherein the security intents define properties related to least one of: confidentiality, integrity, isolation, audibility, and infrastructure, and wherein the properties correspond to respective numeric value ranges or pre-defined values for the security intents.

In Example 26, the subject matter of any one or more of Examples 21-optionally include wherein the security intents are provided within a Helm Chart or a Docker compose file associated with a container image used to execute the workload.

In Example 27, the subject matter of any one or more of Examples 21-26 optionally include wherein the operations to dynamically monitor the execution of the workload are implemented with a trust coordination framework hosted at the orchestrator.

In Example 28, the subject matter of Example 27 optionally includes wherein the operations to adapt the execution environment and control the execution of the workload are based on use of a security policy provided from a plurality of security policies, and wherein the security policy is applicable to a plurality of computing nodes in the cluster.

In Example 29, the subject matter of Example 28 optionally includes wherein the instructions further configure the processing circuitry to cause operations that: determine another computing node of the plurality of computing nodes in the cluster; forward the identified security intents to the another computing node; and forward the workload or results from the execution of the workload to the another computing node.

In Example 30, the subject matter of any one or more of Examples 21-29 optionally include wherein the cluster includes multiple sets of processing circuitry corresponding to a respective computing node, and wherein the multiple sets of processing circuitry include at least one central processing unit (CPU), graphics processing unit (GPU), or accelerator, at the respective computing node.

Example 31 is at least one non-transitory machine-readable storage medium comprising instructions stored thereupon, which when executed by processing circuitry of an orchestrator of a cluster, cause the processing circuitry to: identify a workload for execution; identify security intents that define levels of respective security requirements for the execution of the workload; select a computing node of the cluster for execution of the workload, based on the identified security intents; adapt an execution environment of the selected computing node, based on the identified security intents; and dynamically monitor the execution of the workload on the selected computing node, to verify compliance with the identified security intents in response to changed security conditions during the execution of the workload.

In Example 32, the subject matter of Example 31 optionally includes wherein the execution environment includes a container, a virtual machine, or an operating system.

In Example 33, the subject matter of any one or more of Examples 31-32 optionally include wherein to adapt the execution environment includes to: isolate the execution environment on the selected computing node; or perform a security update to the execution environment.

In Example 34, the subject matter of any one or more of Examples 31-33 optionally include wherein the instructions further cause the processing circuitry to: perform scanning of the execution environment and the workload to identify common vulnerabilities and exposures (CVEs); wherein to adapt the execution environment is based on a remedial action in response to the identified CVEs.

In Example 35, the subject matter of any one or more of Examples 31-34 optionally include wherein the security intents define properties related to least one of: confidentiality, integrity, isolation, audibility, and infrastructure, and wherein the properties correspond to respective numeric value ranges or pre-defined values for the security intents.

In Example 36, the subject matter of any one or more of Examples 31-optionally include wherein the security intents are provided within a Helm Chart or a Docker compose file associated with a container image used to execute the workload.

In Example 37, the subject matter of any one or more of Examples 31-36 optionally include wherein operations to dynamically monitor the execution of the workload are implemented with a trust coordination framework hosted at the orchestrator.

In Example 38, the subject matter of Example 37 optionally includes wherein to adapt the execution environment and control the execution of the workload are based on use of a security policy provided from a plurality of security policies, and wherein the security policy is applicable to a plurality of computing nodes in the cluster.

In Example 39, the subject matter of Example 38 optionally includes wherein the instructions further cause the processing circuitry to: determine another computing node of the plurality of computing nodes in the cluster; forward the identified security intents to the another computing node; and forward the workload or results from the execution of the workload to the another computing node.

In Example 40, the subject matter of any one or more of Examples 31-39 optionally include wherein the cluster includes multiple sets of processing circuitry corresponding to a respective computing node, and wherein the multiple sets of processing circuitry include at least one central processing unit (CPU), graphics processing unit (GPU), or accelerator, at the respective computing node.

Example 41 is at least one machine-readable medium including instructions that, when executed by processing circuitry, cause the processing circuitry to perform operations to implement of any of Examples 1-40.

Example 42 is an apparatus comprising means to implement of any of Examples 1-40.

Example 43 is a system to implement of any of Examples 1-40.

Example 44 is a method to implement of any of Examples 1-40.

### Overview of Edge Computing Environments

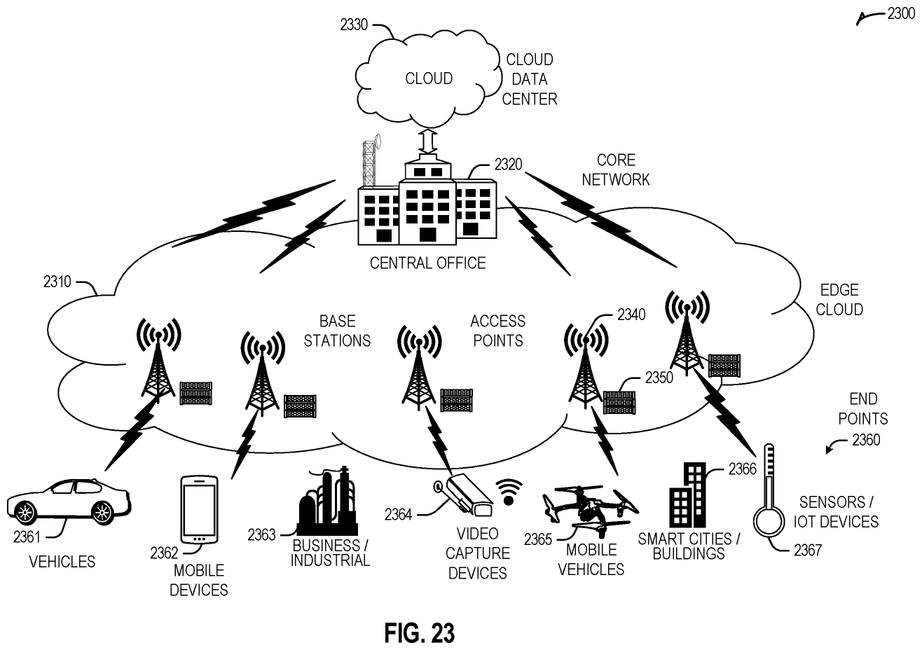

FIG. 23 is a block diagram 2300 showing an overview of a configuration for edge computing, which includes a layer of processing referenced in many of the current examples as an “edge cloud.” As shown, the edge cloud 2310 is co-located at an edge location, such as an access point or base station 2340, a local processing hub 2350, or a central office 2320, and thus may include multiple entities, devices, and equipment instances. The edge cloud 2310 is located much closer to the endpoint (consumer and producer) data sources 2360 (e.g., autonomous vehicles 2361, user equipment 2362, business and industrial equipment 2363, video capture devices 2364, mobile vehicles (e.g., drones) 2365, smart cities and building devices 2366, sensors and IoT devices 2367, etc.) than the cloud data center 2330. Compute, memory, and storage resources which are offered at the edges in the edge cloud 2310 are critical to providing ultra-low latency response times for services and functions used by the endpoint data sources 2360 as well as reduce network backhaul traffic from the edge cloud 2310 toward cloud data center 2330 thus improving energy consumption and overall network usages among other benefits.

Compute, memory, and storage are scarce resources, and generally, decrease depending on the edge location (e.g., fewer processing resources being available at consumer end point devices than at a base station or at a central office). However, the closer that the edge location is to the endpoint (e.g., UEs), the more that space and power are constrained. Thus, edge computing, as a general design principle, attempts to minimize the resources needed for network services, through the distribution of more resources which are located closer both geographically and in-network access time. In this manner, edge computing attempts to bring the compute resources to the workload data where appropriate, or bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge,” “close edge,” “local edge,” “middle edge,” or “far edge” layers, depending on latency, distance, and timing characteristics.

Edge computing is a developing paradigm where computing is performed at or closer to the “edge” of a network, typically through the use of a compute platform (e.g., x86, AMD or ARM hardware architectures) implemented at base stations, gateways, network routers, or other devices which are much closer to end point devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with compute hardware that performs virtualized network functions and offers compute resources for the execution of services and consumer functions for connected devices. Within edge computing networks, there may be scenarios in services in which the compute resource will be “moved” to the data, as well as scenarios in which the data will be “moved” to the compute resource. Or as an example, base station compute, acceleration and network resources can provide services to scale to workload demands on an as-needed basis by activating dormant capacity (subscription, capacity-on-demand) to manage corner cases, emergencies or to provide longevity for deployed resources over a significantly longer implemented lifecycle.

In contrast to the network architecture of FIG. 23, traditional endpoint (e.g., UE, vehicle-to-vehicle (V2V), vehicle-to-everything (V2X), etc.) applications are reliant on local device or remote cloud data storage and processing to exchange and coordinate information. A cloud data arrangement allows for long-term data collection and storage but is not optimal for highly time-varying data, such as a collision, traffic light change, etc. and may fail in attempting to meet latency challenges.

Depending on the real-time requirements in a communications context, a hierarchical structure of data processing and storage nodes may be defined in an edge computing deployment. For example, such a deployment may include local ultra-low-latency processing, regional storage, and processing as well as remote cloud data center-based storage and processing. Key performance indicators (KPIs) may be used to identify where sensor data is appropriately transferred and where it is processed or stored. This typically depends on the ISO layer dependency of the data. For example, lower layer (PHY, MAC, routing, etc.) data typically changes quickly and is better handled locally to meet latency requirements. Higher layer data such as Application-Layer data is typically less time-critical and may be stored and processed in a remote cloud data center.

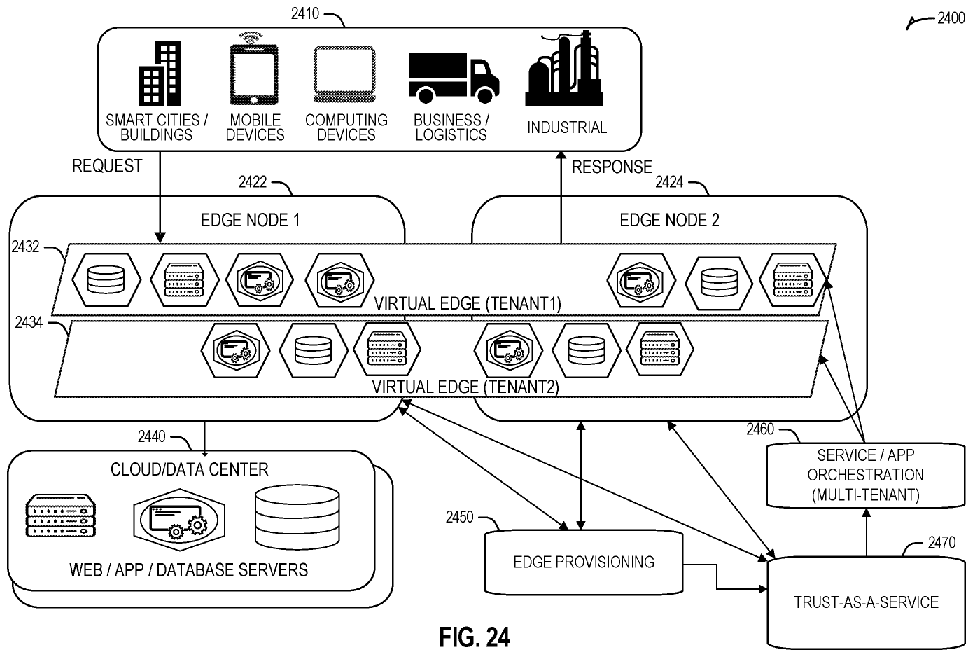

FIG. 24 illustrates deployment and orchestration for virtual edge configurations across an edge computing system operated among multiple edge nodes and multiple tenants. Specifically, FIG. 24 depicts coordination of a first edge node 2422 and a second edge node 2424 in an edge computing system 2400, to fulfill requests and responses for various client endpoints 2410 (e.g., smart cities/building systems, mobile devices, computing devices, business/logistics systems, industrial systems, etc.), which access various virtual edge instances. The virtual edge instances 2432, 2434 (or virtual edges) provide edge compute capabilities and processing in an edge cloud, with access to a cloud/data center 2440 for higher-latency requests for websites, applications, database servers, etc. Thus, the edge cloud enables coordination of processing among multiple edge nodes for multiple tenants or entities.

In the example of FIG. 24, these virtual edge instances include a first virtual edge instance 2432, offered to a first tenant (Tenant 1), which offers a first combination of edge storage, computing, and services; and a second virtual edge instance 2434, offering a second combination of edge storage, computing, and services, to a second tenant (Tenant 2). The virtual edge instances 2432, 2434 are distributed among the edge nodes 2422, 2424, and may include scenarios in which a request and response are fulfilled from the same or different edge nodes. The configuration of the individual edge nodes 2422, 2424 to operate in a distributed yet coordinated fashion occurs based on edge provisioning functions 2450. The functionality of the edge nodes 2422, 2424 to provide coordinated operation for applications and services, among multiple tenants, occurs based on orchestration functions 2460.

It should be understood that some of the devices in 2410 are multi-tenant devices where Tenant1 may function within a Tenant1 ‘slice’ while a Tenant2 may function within a Tenant2 ‘slice’ (and, in further examples, additional or sub-tenants may exist; and a respective tenant may be specifically entitled and transactionally tied to a specific set of features all the way to specific hardware features). A trusted multi-tenant device may further contain a tenant-specific cryptographic key such that the combination of a key and a slice may be considered a “root of trust” (RoT) or tenant-specific RoT. A ROT may further be computed dynamically composed using a compute security architecture, such as a DICE (Device Identity Composition Engine) architecture where a DICE hardware building block is used to construct layered trusted computing base contexts for secured and authenticated layering of device capabilities (such as with use of a Field Programmable Gate Array (FPGA)). The RoT also may be used for a trusted computing context to support respective tenant operations, etc. Use of this ROT and the compute security architecture may be enhanced by the attestation operations further discussed herein.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes consisting of containers, FaaS (function as a service) engines, servlets, servers, or other computation abstraction may be partitioned according to a DICE layering and fan-out structure to support a RoT context for each. Accordingly, the respective RoTs spanning devices in 2410, 2422, and 2440 may coordinate the establishment of a distributed trusted computing base (DTCB) such that a tenant-specific virtual trusted secure channel linking all elements end-to-end can be established.

Further, it will be understood that a container may have data or workload-specific keys protecting its content from a previous edge node. As part of the migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

As an example, the edge computing system may be extended to provide orchestration of multiple applications through the use of containers (a contained, deployable unit of software that provides code and needed dependencies), in a multi-owner, multi-tenant environment. A multi-tenant orchestrator may be used to perform key management, trust anchor management, and other compute security functions related to the provisioning and lifecycle of the trusted ‘slice’ concept in FIG. 24. An orchestrator may use a DICE layering and fan-out construction to create a root of trust context that is tenant specific. Thus, orchestration functions, provided by an orchestrator, may participate as a tenant-specific orchestration provider.

Accordingly, an edge-computing system may be configured to fulfill requests and responses for various client endpoints from multiple virtual edge instances (and, from a cloud or remote data center, not shown). The use of these virtual edge instances supports multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications, latency-sensitive applications, latency-critical applications, user plane applications, networking applications, etc.). The virtual edge instances may also be spanned across systems of multiple owners at different geographic locations (or respective computing systems and resources which are co-owned or co-managed by multiple owners).

For instance, a respective edge node 2422, 2424 may implement the use of containers, such as with the use of a container “pod” 2426, 2428 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices of virtual edge instances 2432, 2434 are partitioned according to the needs of a respective container.

With the use of container pods, a pod controller oversees the partitioning and allocation of containers and resources. The pod controller receives instructions from an orchestrator (e.g., performing orchestration functions 2460) that instructs the controller on how to appropriately partition physical resources and for what duration, such as by receiving key performance indicator (KPI) targets based on SLA contracts. The pod controller determines which container uses which resources and for how long to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a compute security role that prevents the assignment of resources until the right tenant authenticates or prevents provisioning of data or a workload to a container until an attestation result is satisfied.

Also, with the use of container pods, tenant boundaries can still exist but in the context of a respective pod of containers. If a respective tenant-specific pod has a tenant-specific pod controller, there may be a shared pod controller that consolidates resource allocation requests to avoid typical resource starvation situations. Further controls may be provided to ensure the attestation and trustworthiness of the pod and pod controller. For instance, the orchestration functions 2460 or an implementing orchestrator may provision an attestation verification policy to local pod controllers that perform attestation verification. If an attestation satisfies a policy for a first tenant pod controller but not a second tenant pod controller, then the second pod may be migrated to a different edge node that does satisfy it. Alternatively, the first pod may be allowed to execute and a different shared pod controller is installed and invoked before the second pod begins executing.

In further examples, edge computing systems may deploy containers in an edge computing system. As a simplified example, a container manager is adapted to launch containerized pods, functions, and functions-as-a-service instances through execution via compute nodes, or to separately execute containerized virtualized network functions through execution via compute nodes. This arrangement may be adapted for use by multiple tenants in system arrangement, where containerized pods, functions, and functions-as-a-service instances are launched within virtual machines specific to an individual tenant (aside from the execution of virtualized network functions).

Within the edge cloud, a first edge node 2422 (e.g., operated by a first owner) and a second edge node 2424 (e.g., operated by a second owner) may operate or respond to a container orchestrator to coordinate the execution of various applications within the virtual edge instances offered for respective tenants. For instance, the edge nodes 2422, 2424 may be coordinated based on edge provisioning functions 2450, while the operation of the various applications is coordinated with orchestration functions 2460.

Various system arrangements may provide an architecture that treats VMs, Containers, and Functions equally in terms of application composition (and resulting applications are combinations of these three ingredients). A respective ingredient may involve the use of one or more accelerator (e.g., FPGA, ASIC, cryptographic execution) components as a local backend. In this manner, applications can be split across multiple edge owners, coordinated by an orchestrator.

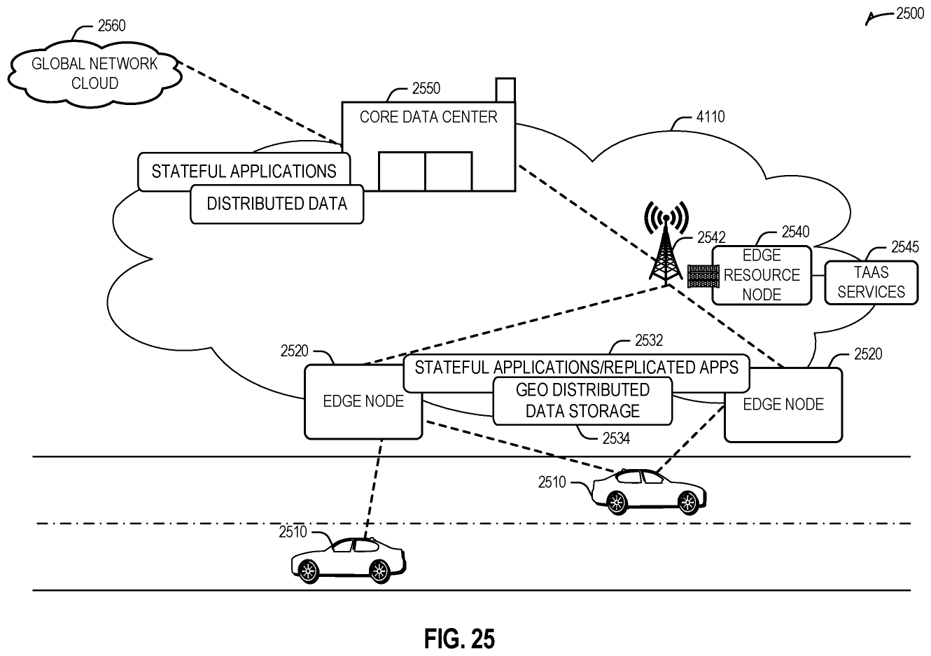

It should be appreciated that the edge computing systems and arrangements discussed herein may be applicable in various solutions, services, and/or use cases. As an example, FIG. 25 shows a simplified vehicle compute and communication use case involving mobile access to applications in an edge computing system 2500 that implements an edge cloud 2310 connected to Trust-as-a-Service (TaaS) instances 2545. In this use case, a client compute node 2510 may be embodied as in-vehicle compute systems (e.g., in-vehicle navigation and/or infotainment systems) located in corresponding vehicles that communicate with the edge gateway nodes 2520 during traversal of a roadway. For instance, edge gateway nodes 2520 may be located in roadside cabinets, which may be placed along the roadway, at intersections of the roadway, or other locations near the roadway. As a vehicle traverses along the roadway, the connection between its client compute node 2510 and a particular edge gateway node 2520 may propagate to maintain a consistent connection and context for the client compute node 2510. The respective nodes of the edge gateway nodes 2520 includes some processing and storage capabilities and, as such, some processing and/or storage of data for the client compute nodes 2510 may be performed on one or more of the edge gateway nodes 2520.

A respective node of the edge gateway nodes 2520 may communicate with one or more edge resource nodes 2540, which are illustratively embodied as compute servers, appliances or components located at or in a communication base station 2542 (e.g., a base station of a cellular network). As discussed above, a respective edge resource node 2540 includes some processing and storage capabilities, and, as such, some processing and/or storage of data for the client compute nodes 2510 may be performed on the edge resource node 2540. For example, the processing of data that is less urgent or important may be performed by the edge resource node 2540, while the processing of data that is of a higher urgency or importance may be performed by edge gateway devices or the client nodes themselves (depending on, for example, the capabilities of a respective component). Further, various wired or wireless communication links (e.g., fiber optic wired backhaul, 5G wireless links) may exist among the edge nodes 2520, edge resource node(s) 2540, core data center 2550, and network cloud 2560.

The edge resource node(s) 2540 also communicate with the core data center 2550, which may include compute servers, appliances, and/or other components located in a central location (e.g., a central office of a cellular communication network). The core data center 2550 may provide a gateway to the global network cloud 2560 (e.g., the Internet) for the edge cloud 2310 operations formed by the edge resource node(s) 2540 and the edge gateway nodes 2520. Additionally, in some examples, the core data center 2550 may include an amount of processing and storage capabilities and, as such, some processing and/or storage of data for the client compute devices may be performed on the core data center 2550 (e.g., processing of low urgency or importance, or high complexity). The edge gateway nodes 2520 or the edge resource nodes 2540 may offer the use of stateful applications 2532 and a geographically distributed data storage 2534 (e.g., database, data store, etc.).

In further examples, FIG. 25 may utilize various types of mobile edge nodes, such as an edge node hosted in a vehicle (e.g., car, truck, tram, train, etc.) or other mobile units, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in a variety of settings, including coordination between some functions or operations at individual endpoint devices or the edge gateway nodes 2520, some others at the edge resource node 2540, and others in the core data center 2550 or the global network cloud 2560.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code is executed. The container may be any isolated-execution entity (a workload execution environment) such as a process, a Docker or Kubernetes container, a virtual machine, etc. Within the edge computing system, various data center, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, the container is “spun down” (e.g., deactivated and/or deallocated) on the infrastructure in response to the execution being completed.

Further aspects of FaaS may enable deployment of edge functions in a service fashion, including support of respective functions that support edge computing as a service. Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require deployment or configuration).

### Example Internet of Things Architectures

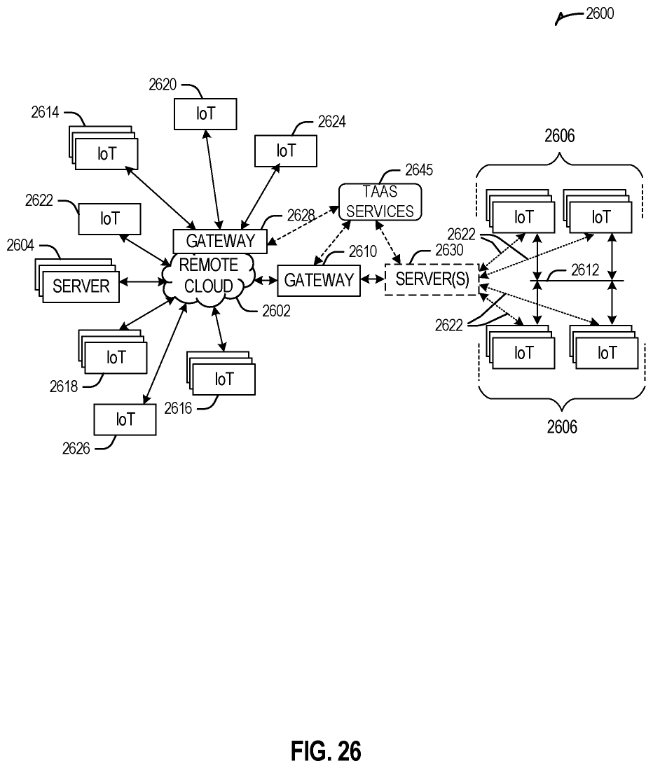

As a more detailed illustration of an Internet of Things (IOT) network, FIG. 26 illustrates a drawing of a cloud or edge computing network 2600, in communication with several IoT devices and a TaaS instance 2645. The IoT is a concept in which a large number of computing devices are interconnected with one other and to the Internet to provide functionality and data acquisition at very low levels. Thus, as used herein, an IoT device may include a semiautonomous device performing a function, such as sensing or control, among others, in communication with other IoT devices and a wider network, such as the Internet.

Often, IoT devices are limited in memory, size, or functionality, allowing larger numbers to be deployed for a similar (or lower) cost compared to the cost of smaller numbers of larger devices. However, an IoT device may be a smartphone, laptop, tablet, or PC, or other larger device. Further, an IoT device may be a virtual device, such as an application on a smartphone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

Returning to FIG. 26, the network 2600 may represent portions of the Internet or may include portions of a local area network (LAN), or a wide area network (WAN), such as a proprietary network for a company. The IoT devices may include any number of different types of devices, grouped in various combinations. For example, a traffic control group 2606 may include IoT devices along streets in a city. These IoT devices may include stoplights, traffic flow monitors, cameras, weather sensors, and the like. The traffic control group 2606, or other subgroups, may be in communication within the network 2600 through wired or wireless links 2608, such as LPWA links, optical links, and the like. Further, a wired or wireless sub-network 2612 may allow the IoT devices to communicate with one another, such as through a local area network, a wireless local area network, and the like. The IoT devices may use another device, such as a gateway 2610 or 2628 to communicate with remote locations such as remote cloud 2602; the IoT devices may also use one or more servers 2630 to facilitate communication within the network 2600 or with the gateway 2610. For example, the one or more servers 2630 may operate as an intermediate network node to support a local edge cloud or fog implementation among a local area network. Further, the gateway 2628 that is depicted may operate in a cloud-to-gateway-to-many edge devices configuration, such as with the various IoT devices (e.g., stations 2614, machines 2620, vehicles 2624) being constrained or dynamic to an assignment and use of resources in the network 2600.

In an example embodiment, the network 2600 can further include or be communicatively coupled to a Trust-a-a-Service instance or deployment configured to perform trust attestation operations within the network 2600, such as that discussed above.

Other example groups of IoT devices may include remote weather stations 2614, local information terminals 2616, alarm systems 2618, automated teller machines 2620, alarm panels 2622, or moving vehicles, such as emergency vehicles 2624 or other vehicles 2626, among many others. These IoT devices may be in communication with other IoT devices, with servers 2604, with another IoT device or system, another edge computing or “fog” computing system, or a combination therein. The groups of IoT devices may be deployed in various residential, commercial, and industrial settings (including in both private or public environments).

As may be seen from FIG. 26, a large number of IoT devices may be communicating through the network 2600. This may allow different IoT devices to request or provide information to other devices autonomously. For example, a group of IoT devices (e.g., the traffic control group 2606) may request a current weather forecast from a group of remote weather stations 2614, which may provide the forecast without human intervention. Further, an emergency vehicle 2624 may be alerted by an automated teller machine 2620 that a burglary is in progress. As the emergency vehicle 2624 proceeds towards the automated teller machine 2620, it may access the traffic control group 2606 to request clearance to the location, for example, by lights turning red to block cross traffic at an intersection in sufficient time for the emergency vehicle 2624 to have unimpeded access to the intersection.

Clusters of IoT devices may be equipped to communicate with other IoT devices as well as with a cloud network. This may allow the IoT devices to form an ad-hoc network between the devices, allowing them to function as a single device, which may be termed a fog device or system. Clusters of IoT devices, such as may be provided by the remote weather stations 2614 or the traffic control group 2606, may be equipped to communicate with other IoT devices as well as with the network 2600. This may allow the IoT devices to form an ad-hoc network between the devices, allowing them to function as a single device, which also may be termed a fog device or system.

In further examples, a variety of topologies may be used for IoT networks comprising IoT devices, with the IoT networks coupled through backbone links to respective gateways. For example, a number of IoT devices may communicate with a gateway, and with each other through the gateway. The backbone links may include any number of wired or wireless technologies, including optical networks, and may be part of a local area network (LAN), a wide area network (WAN), or the Internet. Additionally, such communication links facilitate optical signal paths among both IoT devices and gateways, including the use of MUXing/deMUXing components that facilitate the interconnection of the various devices.

The network topology may include any number of types of IoT networks, such as a mesh network provided with the network using Bluetooth low energy (BLE) links. Other types of IoT networks that may be present include a wireless local area network (WLAN) network used to communicate with IoT devices through IEEE 802.11 (Wi-Fi®) links, a cellular network used to communicate with IoT devices through an LTE/LTE-A (4G) or 5G cellular network, and a low-power wide-area (LPWA) network, for example, a LPWA network compatible with the LoRaWan specification promulgated by the LoRa alliance, or an IPV6 over Low Power Wide-Area Networks (LPWAN) network compatible with a specification promulgated by the Internet Engineering Task Force (IETF).

Further, the respective IoT networks may communicate with an outside network provider (e.g., a tier 2 or tier 3 provider) using any number of communications links, such as an LTE cellular link, a LPWA link, or a link based on the IEEE 802.15.4 standard, such as Zigbee®. The respective IoT networks may also operate with the use of a variety of network and internet application protocols such as the Constrained Application Protocol (CoAP). The respective IoT networks may also be integrated with coordinator devices that provide a chain of links that forms a cluster tree of linked devices and networks.

IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration, and quality of service (QOS) based swarming and coordination/combinations of resources.

An IoT network, arranged as a mesh network, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of the assets and resources. Furthermore, the proper components of infrastructure and resource-based trust and service indices may be inserted to improve the data integrity, quality, assurance, and deliver a metric of data confidence.

### Example Computing Devices

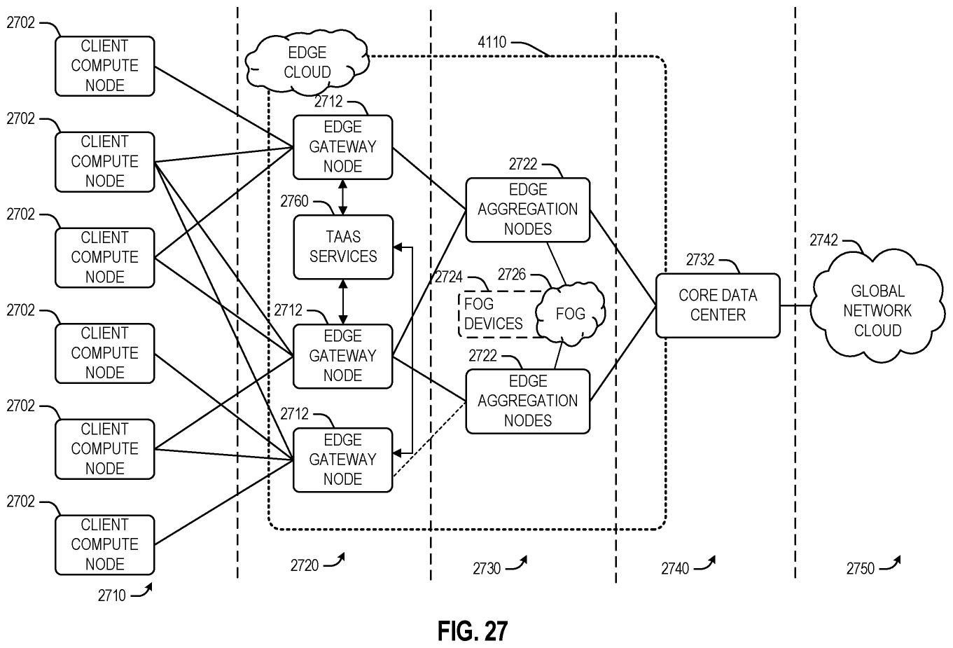

At a more generic level, an edge computing system may be described to encompass any number of deployments operating in the edge cloud 2310, which provide coordination from client and distributed computing devices. FIG. 27 provides a further abstracted overview of layers of distributed compute deployed among an edge computing environment for purposes of illustration.

FIG. 27 generically depicts an edge computing system for providing edge services and applications to multi-stakeholder entities, as distributed among one or more client compute nodes 2702, one or more edge gateway nodes 2712, one or more edge aggregation nodes 2722, one or more core data centers 2732, and a global network cloud 2742, as distributed across layers of the network. The implementation of the edge computing system may be provided at or on behalf of a telecommunication service provider (“telco” or “TSP”), internet-of-things service provider, a cloud service provider (CSP), enterprise entity, or any other number of entities. Various forms of wired or wireless connections may be configured to establish connectivity among the nodes 2702, 2712, 2722, and data centers 2732, including interconnections among such nodes (e.g., connections among edge gateway nodes 2712, and connections among edge aggregation nodes 2722). Such connectivity and federation of these nodes may be assisted with the use of TaaS services 2760 and service instances, as discussed herein.

A respective node or device of the edge computing system is located at a particular layer corresponding to layers 2710, 2720, 2730, 2740, and 2750. For example, the client compute nodes 2702 are located at an endpoint layer 2710, while the edge gateway nodes 2712 are located at an edge devices layer 2720 (local level) of the edge computing system. Additionally, the edge aggregation nodes 2722 (and/or fog devices 2724, if arranged or operated with or among a fog networking configuration 2726) is located at a network access layer 2730 (an intermediate level). Fog computing (or “fogging”) generally refers to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein apply to fog networks, fogging, and fog configurations. Further, aspects of the edge computing systems discussed herein may be configured as a fog, or aspects of a fog may be integrated into an edge computing architecture.

The core data center 2732 is located at a core network layer 2740 (e.g., a regional or geographically-central level), while the global network cloud 2742 is located at a cloud data center layer 2750 (e.g., a national or global layer). The use of “core” is provided as a term for a centralized network location—deeper in the network—which is accessible by multiple edge nodes or components; however, a “core” does not necessarily designate the “center” or the deepest location of the network. Accordingly, the core data center 2732 may be located within, at, or near the edge cloud 2310.

Although an illustrative number of client compute nodes 2702, edge gateway nodes 2712, edge aggregation nodes 2722, core data centers 2732, and global network clouds 2742 are shown in FIG. 27, it should be appreciated that the edge computing system may include more or fewer devices or systems at respective layers. Additionally, as shown in FIG. 27, the number of components of respective layers 2710, 2720, 2730, 2740, and 2750 generally increases at lower levels (e.g., when moving closer to endpoints). As such, one edge gateway node 2712 may service multiple client compute nodes 2702, and one edge aggregation node 2722 may service multiple edge gateway nodes 2712.

Consistent with the examples provided herein, a client compute node 2702 may be embodied as any type of end point component, device, appliance, or “thing” capable of communicating as a producer or consumer of data. Further, the label “node” or “device” as used in the edge computing system 2700 does not necessarily mean that such node or device operates in a client or minion/follower/agent role; rather, any of the nodes or devices in the edge computing system 2700 refer to individual entities, nodes, or subsystems which include discrete or connected hardware or software configurations to facilitate or use the edge cloud 2310.

As such, the edge cloud 2310 is formed from network components and functional features operated by and within the edge gateway nodes 2712 and the edge aggregation nodes 2722 of layers 2720, 2730, respectively. The edge cloud 2310 may be embodied as any type of network that provides edge computing and/or storage resources which are proximately located to radio access network (RAN) capable endpoint devices (e.g., mobile computing devices, IoT devices, smart devices, etc.), which are shown in FIG. 27 as the client compute nodes 2702. In other words, the edge cloud 2310 may be envisioned as an “edge” which connects the endpoint devices and traditional mobile network access points that serves as an ingress point into service provider core networks, including carrier networks (e.g., Global System for Mobile Communications (GSM) networks, Long-Term Evolution (LTE) networks, 5G networks, etc.), while also providing storage and/or compute capabilities. Other types and forms of network access (e.g., Wi-Fi, long-range wireless networks) may also be utilized in place of or in combination with such 3GPP carrier networks.

In some examples, the edge cloud 2310 may form a portion of or otherwise provide an ingress point into or across a fog networking configuration 2726 (e.g., a network of fog devices 2724, not shown in detail), which may be embodied as a system-level horizontal and distributed architecture that distributes resources and services to perform a specific function. For instance, a coordinated and distributed network of fog devices 2724 may perform computing, storage, control, or networking aspects in the context of an IoT system arrangement. Other networked, aggregated, and distributed functions may exist in the edge cloud 2310 between the cloud data center layer 2750 and the client endpoints (e.g., client compute nodes 2702). Some of these are discussed in the following sections in the context of network functions or service virtualization, including the use of virtual edges and virtual services which are orchestrated for multiple stakeholders.

The edge gateway nodes 2712 and the edge aggregation nodes 2722 cooperate to provide various edge services and compute security features to the client compute nodes 2702. Furthermore, because an individual client compute node 2702 may be stationary or mobile, a respective edge gateway node 2712 may cooperate with other edge gateway devices to propagate presently provided edge services and compute security features as the corresponding client compute node 2702 moves about a region. To do so, respective nodes of the edge gateway nodes 2712 and/or edge aggregation nodes 2722 may support multiple tenancies and multiple stakeholder configurations, in which services from (or hosted for) multiple service providers and multiple consumers may be supported and coordinated across a single or multiple compute devices.

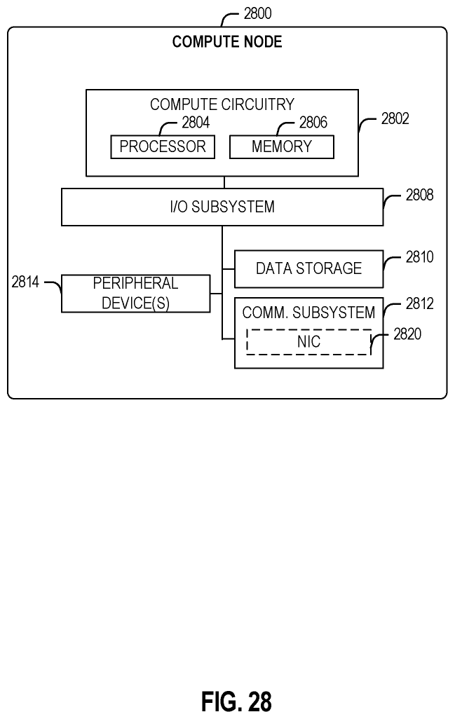

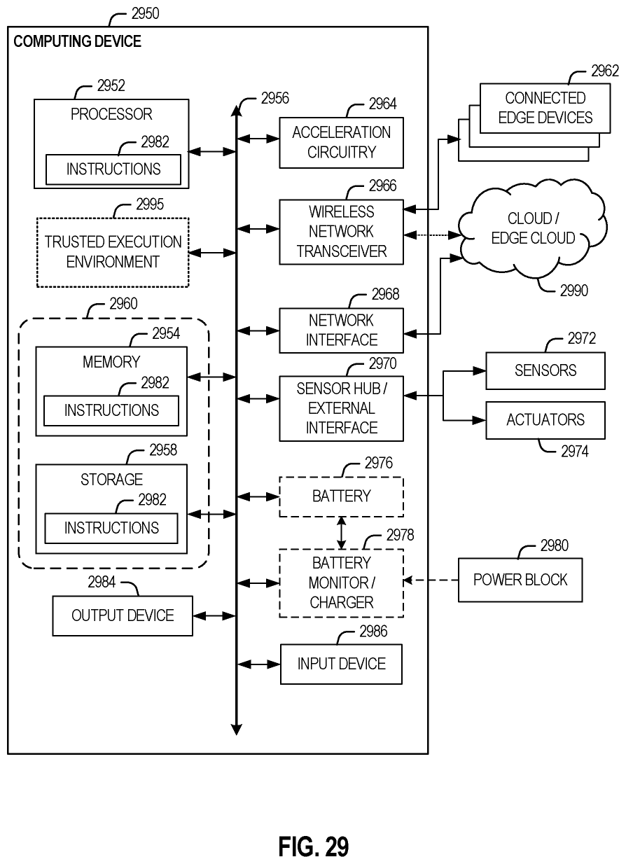

In further examples, any of the compute nodes or devices discussed with reference to the present edge computing systems and environment may be fulfilled based on the components depicted in FIGS. 28 and 29. An edge compute node may be embodied as a type of device, appliance, computer, or other “thing” capable of communicating with other edge, networking, or endpoint components. For example, an edge compute device may be embodied as a personal computer, a server, smartphone, a mobile compute device, a smart appliance, an in-vehicle compute system (e.g., a navigation system), a self-contained device having an outer case, shell, etc., or other devices or systems capable of performing the described functions.

In the simplified example depicted in FIG. 28, an edge compute node 2800 includes a compute engine (also referred to herein as “compute circuitry”) 2802, an input/output (I/O) subsystem 2808, data storage device 2810, a communication circuitry 2812 subsystem, and, optionally, one or more peripheral devices 2814. In other examples, a respective compute device may include other or additional components, such as those used in personal or server computing systems (e.g., a display, peripheral devices, etc.). Additionally, in some examples, one or more of the illustrative components may be incorporated in, or otherwise form a portion of, another component.

The compute node 2800 may be embodied as any type of engine, device, or collection of devices capable of performing various compute functions. In some examples, the compute node 2800 may be embodied as a single device such as an integrated circuit, an embedded system, a field-programmable gate array (FPGA), a system-on-a-chip (SOC), or other integrated system or device. In the illustrative example, the compute node 2800 includes or is embodied as a processor 2804 and a memory 2806. The processor 2804 may be embodied as any type of processor capable of performing the functions described herein (e.g., executing an application). For example, the processor 2804 may be embodied as a multi-core processor(s), a microcontroller, a processing unit, a specialized or special purpose processing unit, or other processor or processing/controlling circuit. In some examples, the processor 2804 may be embodied as, include, or be coupled to an FPGA, an application-specific integrated circuit (ASIC), reconfigurable hardware or hardware circuitry, or other specialized hardware to facilitate performance of the functions described herein. Also in some examples, the processor 2804 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), dedicated compute circuitry, storage devices, or AI or specialized hardware (e.g., GPUs, programmed FPGAs, Network Processing Units (NPUs), Infrastructure Processing Units (IPUs), Storage Processing Units (SPUs), AI Processors (APUs), Data Processing Units (DPUs), Edge Processing Units (EPUs), or other specialized compute units such as a cryptographic processing unit/accelerator). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. Thus, any of the C2E techniques described herein and their accompanying attestation, trust, security, provisioning, testing, simulation, or orchestration functions may be coordinated by an xPU. However, it will be understood that an xPU, a SOC, a CPU, and other variations of the processor 2804 may work in coordination with each other to execute many types of operations and instructions within and on behalf of the compute node 2800.

The main memory 2806 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In one example, the memory device is a block addressable memory device, such as those based on NAND or NOR technologies. A memory device may also include a three-dimensional crosspoint memory device (e.g., Intel 3D XPoint™ memory), or other byte-addressable write-in-place nonvolatile memory devices. The memory device may refer to the die itself and/or to a packaged memory product. In some examples, 3D crosspoint memory (e.g., Intel 3D XPoint™ memory) may comprise a transistor-less stackable cross-point architecture in which memory cells sit at the intersection of word lines and bit lines and are individually addressable and in which bit storage is based on a change in bulk resistance. In some examples, all or a portion of the main memory 2806 may be integrated into the processor 2804. The main memory 2806 may store various software and data used during operation such as one or more applications, data operated on by the application(s), libraries, and drivers.

The compute circuitry 2802 is communicatively coupled to other components of the compute node 2800 via the I/O subsystem 2808, which may be embodied as circuitry and/or components to facilitate input/output operations with the compute circuitry 2802 (e.g., with the processor 2804 and/or the main memory 2806) and other components of the compute circuitry 2802. For example, the I/O subsystem 2808 may be embodied as, or otherwise include memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 2808 may form a portion of a system-on-a-chip (SoC) and be incorporated, along with one or more of the processor 2804, the main memory 2806, and other components of the compute circuitry 2802, into the compute circuitry 2802.

The one or more illustrative data storage devices 2810 may be embodied as any type of device configured for short-term or long-term storage of data such as, for example, memory devices and circuits, memory cards, hard disk drives, solid-state drives, or other data storage devices. A respective data storage device 2810 may include a system partition that stores data and firmware code for the data storage device 2810. A respective data storage device 2810 may also include one or more operating system partitions that store data files and executables for operating systems depending on, for example, the type of compute node 2800.

The communication circuitry 2812 may be embodied as any communication circuit, device, or collection thereof, capable of enabling communications over a network between the compute circuitry 2802 and another compute device (e.g., an edge gateway node 2712 of the edge computing system 2700). The communication circuitry 2812 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, an IoT protocol such as IEEE 802.15.4 or ZigBee®, low-power wide-area network (LPWAN) or low-power wide-area (LPWA) protocols, etc.) to effect such communication.

The illustrative communication circuitry 2812 includes a network interface controller (NIC) 2820, which may also be referred to as a host fabric interface (HFI). The NIC 2820 may be embodied as one or more add-in-boards, daughter cards, network interface cards, controller chips, chipsets, or other devices that may be used by the compute node 2800 to connect with another compute device (e.g., an edge gateway node 2712). In some examples, the NIC 2820 may be embodied as part of a system-on-a-chip (SoC) that includes one or more processors or included on a multichip package that also contains one or more processors. In some examples, the NIC 2820 may include a local processor (not shown) and/or a local memory and storage (not shown) that are local to the NIC 2820. In such examples, the local processor of the NIC 2820 (which can include general-purpose accelerators or specific accelerators) may be capable of performing one or more of the functions of the compute circuitry 2802 described herein. Additionally, or alternatively, the local memory of the NIC 2820 may be integrated into one or more components of the client compute node at the board level, socket level, chip level, and/or other levels.

Additionally, in some examples, a respective compute node 2800 may include one or more peripheral devices 2814. Such peripheral devices 2814 may include any type of peripheral device found in a compute device or server such as audio input devices, a display, other input/output devices, interface devices, and/or other peripheral devices, depending on the particular type of the compute node 2800. In further examples, the compute node 2800 may be embodied by a respective edge compute node in an edge computing system (e.g., client compute node 2702, edge gateway node 2712, edge aggregation node 2722) or like forms of appliances, computers, subsystems, circuitry, or other components.

In a more detailed example, FIG. 29 illustrates a block diagram of an example of components that may be present in an edge computing device (or node) 2950 for implementing the techniques (e.g., operations, processes, methods, and methodologies) described herein. The edge computing node 2950 provides a closer view of the respective components of node 2800 when implemented as or as part of a computing device (e.g., as a mobile device, a base station, server, gateway, etc.). The edge computing node 2950 may include any combinations of the components referenced above, and it may include any device usable with an edge communication network or a combination of such networks. The components may be implemented as integrated circuits (ICs), portions thereof, discrete electronic devices, or other modules, logic, instruction sets, programmable logic or algorithms, hardware, hardware accelerators, software, firmware, or a combination thereof adapted in the edge computing node 2950, or as components otherwise incorporated within a chassis of a larger system.

The edge computing node 2950 may include processing circuitry in the form of a processor 2952, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 2952 may be a part of a system on a chip (SoC) in which the processor 2952 and other components are formed into a single integrated circuit, or a single package, such as the Edison™ or Galileo™ SoC boards from Intel Corporation, Santa Clara, California. As an example, the processor 2952 may include an Intel® Architecture Core™ based processor, such as a Quark™, an Atom™, an i3, an i5, an i7, an i9, or an MCU-class processor, or another such processor available from Intel®. However, any number other processors may be used, such as available from Advanced Micro Devices, Inc. (AMD) of Sunnyvale, California, a MIPS-based design from MIPS Technologies, Inc. of Sunnyvale, California, an ARM-based design licensed from ARM Holdings, Ltd. or a customer thereof, or their licensees or adopters. The processors may include units such as an A5-A14 processor from Apple® Inc., a Snapdragon™ processor from Qualcomm® Technologies, Inc., or an OMAP™ processor from Texas Instruments, Inc. The processor 2952 and accompanying circuitry may be provided in a single socket form factor, multiple socket form factor, or a variety of other formats, including in limited hardware configurations or configurations that include fewer than all elements shown in FIG. 29.

The processor 2952 may communicate with a system memory 2954 over an interconnect 2956 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP), or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems, and so forth, a storage 2958 may also couple to the processor 2952 via the interconnect 2956. In an example, the storage 2958 may be implemented via a solid-state disk drive (SSDD). Other devices that may be used for the storage 2958 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin-transfer torque (STT)-MRAM, a spintronic magnetic junction memory-based device, a magnetic tunneling junction (MTJ) based device, a DW (Domain Wall) and SOT (Spin-Orbit Transfer) based device, a thyristor-based memory device, or a combination of any of the above, or other memory.

In low power implementations, the storage 2958 may be on-die memory or registers associated with the processor 2952. However, in some examples, the storage 2958 may be implemented using a micro hard disk drive (HDD) or solid-state drive (SSD). Further, any number of new technologies may be used for the storage 2958 in addition to, or instead of, the technologies described, such resistance change memories, phase change memories, holographic memories, or chemical memories, among others.

The components may communicate over the interconnect 2956. The interconnect 2956 may include any number of technologies, including industry-standard architecture (ISA), extended ISA (EISA), peripheral component interconnect (PCI), peripheral component interconnect extended (PCI-X), PCI express (PCIe), or any number of other technologies. The interconnect 2956 may be a proprietary bus, for example, used in an SoC based system. Other bus systems may be included, such as an I2C interface, an SPI interface, point to point interfaces, and a power bus, among others.

The interconnect 2956 may couple the processor 2952 to a transceiver 2966, for communications with the connected edge devices 2962. The transceiver 2966 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 2962. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 2966 (or multiple transceivers) may communicate using multiple standards or radios for communications at a different range. For example, the edge computing node 2950 may communicate with close devices, e.g., within about 10 meters, using a local transceiver based on BLE, or another low power radio, to save power. More distant connected edge devices 2962, e.g., within about 50 meters, may be reached over ZigBee or other intermediate power radios. Both communications techniques may take place over a single radio at different power levels or may take place over separate transceivers, for example, a local transceiver using BLE and a separate mesh transceiver using ZigBee®.

A wireless network transceiver 2966 (e.g., a radio transceiver) may be included to communicate with devices or services in the edge cloud 2990 via local or wide area network protocols. The wireless network transceiver 2966 may be an LPWA transceiver that follows the IEEE 802.15.4, or IEEE 802.15.4g standards, among others. The edge computing node 2950 may communicate over a wide area using LoRaWAN™ (Long Range Wide Area Network) developed by Semtech and the LoRa Alliance. The techniques described herein are not limited to these technologies but may be used with any number of other cloud transceivers that implement long-range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 2966, as described herein. For example, the transceiver 2966 may include a cellular transceiver that uses spread spectrum (SPA/SAS) communications for implementing high-speed communications. Further, any number of other protocols may be used, such as Wi-Fi® networks for medium speed communications and provision of network communications. The transceiver 2966 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 2968 may be included to provide a wired communication to nodes of the edge cloud 2990 or other devices, such as the connected edge devices 2962 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, Time Sensitive Networks (TSN), among many others. An additional NIC 2968 may be included to enable connecting to a second network, for example, a first NIC 2968 providing communications to the cloud over Ethernet, and a second NIC 2968 providing communications to other devices over another type of network.

Given the variety of types of applicable communications from the device to another component or network, applicable communications circuitry used by the device may include or be embodied by any one or more of components (e.g., circuitry 2964, transceiver 2966, NIC 2968, or interface 2970). Accordingly, in various examples, applicable means for communicating (e.g., receiving, transmitting, etc.) may be embodied by such communications circuitry.

The edge computing node 2950 may include or be coupled to acceleration circuitry 2964, which may be embodied by one or more AI accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. Accordingly, in various examples, applicable means for acceleration may be embodied by such acceleration circuitry.

The interconnect 2956 may couple the processor 2952 to a sensor hub or external interface 2970 that is used to connect additional devices or subsystems. The devices may include sensors 2972, such as accelerometers, level sensors, flow sensors, optical light sensors, camera sensors, temperature sensors, a global navigation system (e.g., GPS) sensors, pressure sensors, barometric pressure sensors, and the like. The hub or interface 2970 further may be used to connect the edge computing node 2950 to actuators 2974, such as power switches, valve actuators, an audible sound generator, a visual warning device, and the like.

In some optional examples, various input/output (I/O) devices may be present within or connected to, the edge computing node 2950. For example, a display or other output device 2984 may be included to show information, such as sensor readings or actuator position. An input device 2986, such as a touch screen or keypad may be included to accept input. An output device 2984 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the edge computing node 2950. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 2976 may power the edge computing node 2950, although, in examples in which the edge computing node 2950 is mounted in a fixed location, it may have a power supply coupled to an electrical grid, or the battery may be used as a backup or for temporary capabilities. The battery 2976 may be a lithium-ion battery, or a metal-air battery, such as a zinc-air battery, an aluminum-air battery, a lithium-air battery, and the like.

A battery monitor/charger 2978 may be included in the edge computing node 2950 to track the state of charge (SoCh) of the battery 2976. The battery monitor/charger 2978 may be used to monitor other parameters of the battery 2976 to provide failure predictions, such as the state of health (SoH) and the state of function (SoF) of the battery 2976. The battery monitor/charger 2978 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 2978 may communicate the information on the battery 2976 to the processor 2952 over the interconnect 2956. The battery monitor/charger 2978 may also include an analog-to-digital (ADC) converter that enables the processor 2952 to directly monitor the voltage of the battery 2976 or the current flow from the battery 2976. The battery parameters may be used to determine actions that the edge computing node 2950 may perform, such as transmission frequency, mesh network operation, sensing frequency, and the like.

A power block 2980, or other power supply coupled to a grid, may be coupled with the battery monitor/charger 2978 to charge the battery 2976. In some examples, the power block 2980 may be replaced with a wireless power receiver to obtain the power wirelessly, for example, through a loop antenna in the edge computing node 2950. A wireless battery charging circuit, such as an LTC4020 chip from Linear Technologies of Milpitas, California, among others, may be included in the battery monitor/charger 2978. The specific charging circuits may be selected based on the size of the battery 2976, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 2958 may include instructions 2982 in the form of software, firmware, or hardware commands to implement the techniques described herein. Although such instructions 2982 are shown as code blocks included in the memory 2954 and the storage 2958, it may be understood that any of the code blocks may be replaced with hardwired circuits, for example, built into an application-specific integrated circuit (ASIC).

Also in a specific example, the instructions 2982 on the processor 2952 (separately, or in combination with the instructions 2982 of the machine readable medium 2960) may configure execution or operation of a trusted execution environment (TEE) 2995. In an example, the TEE 2995 operates as a protected area accessible to the processor 2952 for secure execution of instructions and secure access to data. Various implementations of the TEE 2995, and an accompanying secure area in the processor 2952 or the memory 2954 may be provided, for instance, through use of Intel® Software Guard Extensions (SGX), AMD® Secure Encrypted Virtualization (SEV), or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the edge computing node 2950 through the TEE 2995 and the processor 2952.

In an example, the instructions 2982 provided via memory 2954, the storage 2958, or the processor 2952 may be embodied as a non-transitory, machine-readable medium 2960 including code to direct the processor 2952 to perform electronic operations in the edge computing node 2950. The processor 2952 may access the non-transitory, machine-readable medium 2960 over the interconnect 2956. For instance, the non-transitory, machine-readable medium 2960 may be embodied by devices described for the storage 2958 or may include specific storage units such as optical disks, flash drives, or any number of other hardware devices. The non-transitory, machine-readable medium 2960 may include instructions to direct the processor 2952 to perform a specific sequence or flow of actions, for example, as described with respect to the flowchart(s) and block diagram(s) of operations and functionality depicted above. As used herein, the terms “machine-readable medium,” “computer-readable medium,” “machine-readable storage,” and “computer-readable storage” are interchangeable.

In an example embodiment, the edge computing node 2950 can be implemented using components/modules/blocks 2952-2986 which are configured as IP Blocks. An individual IP Block may contain a hardware RoT (e.g., device identifier composition engine, or DICE), where a DICE key may be used to identify and attest the IP Block firmware to a peer IP Block or remotely to one or more of components/modules/blocks 2962-2980. Thus, it will be understood that the node 2950 itself may be implemented as a SoC or standalone hardware package.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

The block diagrams of FIGS. 28 and 29 are intended to depict a high-level view of components of a device, subsystem, or arrangement of an edge computing node. However, it will be understood that some of the components shown may be omitted, additional components may be present, and a different arrangement of the components shown may occur in other implementations.

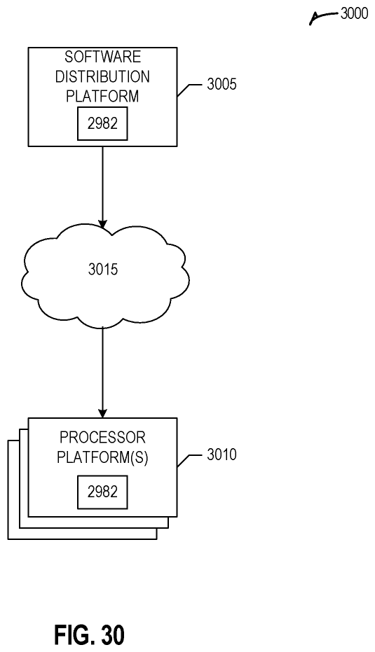

FIG. 30 illustrates an example software distribution platform 3005 to distribute software, such as the example computer readable instructions 2982 of FIG. 29, to one or more devices, such as example processor platform(s) 30 and/or other example connected edge devices or systems discussed herein. The example software distribution platform 3005 may be implemented by any computer server, data facility, cloud service, etc., capable of storing and transmitting software to other computing devices. Example connected edge devices may be customers, clients, managing devices (e.g., servers), third parties (e.g., customers of an entity owning and/or operating the software distribution platform 3005). Example connected edge devices may operate in commercial and/or home automation environments. In some examples, a third party is a developer, a seller, and/or a licensor of software such as the example computer readable instructions 2982 of FIG. 29. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 30, the software distribution platform 3005 includes one or more servers and one or more storage devices that store the computer readable instructions 2982. The one or more servers of the example software distribution platform 3005 are in communication with a network 3015, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 2982 from the software distribution platform 3005. For example, the software, which may correspond to example computer readable instructions, may be downloaded to the example processor platform(s), which is/are to execute the computer readable instructions 2982. In some examples, one or more servers of the software distribution platform 3005 are communicatively connected to one or more security domains and/or security devices through which requests and transmissions of the example computer readable instructions 2982 must pass. In some examples, one or more servers of the software distribution platform 3005 periodically offer, transmit, and/or force updates to the software (e.g., the example computer readable instructions 2982 of FIG. 29) to ensure improvements, patches, updates, etc. are distributed and applied to the software at the end user devices.

In the illustrated example of FIG. 30, the computer readable instructions 2982 are stored on storage devices of the software distribution platform 3005 in a particular format. A format of computer readable instructions includes, but is not limited to a particular code language (e.g., Java, JavaScript, Python, C, C #, SQL, HTML, etc.), and/or a particular code state (e.g., uncompiled code (e.g., ASCII), interpreted code, linked code, executable code (e.g., a binary), etc.). In some examples, the computer readable instructions 2982 stored in the software distribution platform 3005 are in a first format when transmitted to the example processor platform(s) 3010. In some examples, the first format is an executable binary in which particular types of the processor platform(s) 3010 can execute. However, in some examples, the first format is uncompiled code that requires one or more preparation tasks to transform the first format to a second format to enable execution on the example processor platform(s) 3010. For instance, the receiving processor platform(s) 3000 may need to compile the computer readable instructions 2982 in the first format to generate executable code in a second format that is capable of being executed on the processor platform(s) 2910. In still other examples, the first format is interpreted code that, upon reaching the processor platform(s) 3010, is interpreted by an interpreter to facilitate execution of instructions.

Implementation of the preceding techniques may be accomplished through any number of specifications, configurations, or example deployments of hardware and software. It should be understood that the functional units or capabilities described in this specification may have been referred to or labeled as components or modules, to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field-programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center), than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set, or may be distributed over different locations including over different storage devices, and may exist, at least partially, merely as electronic signals on a system or network. The components or modules may be passive or active, including agents operable to perform desired functions.

In the above Detailed Description, various features may be grouped to streamline the disclosure. However, claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment.

1. At least one non-transitory machine-readable storage medium comprising instructions stored thereupon, which when executed by processing circuitry of a computing node, cause the processing circuitry to:
identify a workload for execution on the computing node;
identify security intents that define levels of respective security requirements for the execution of the workload on the computing node;
adapt an execution environment of the computing node, based on the identified security intents; and
control the execution of the workload within the execution environment, based on the identified security intents, to dynamically monitor and adapt to changing security conditions during the execution of the workload.

2. The machine-readable storage medium of claim 1, wherein the execution environment includes at least one: container, virtual machine, operating system.

3. The machine-readable storage medium of claim 1, wherein to adapt the execution environment includes to: isolate the execution environment on the computing node; migrate the workload to another computing node; or perform a security update to the execution environment.

4. The machine-readable storage medium of claim 1, wherein the instructions further cause the processing circuitry to:
perform scanning of the execution environment and the workload to identify common vulnerabilities and exposures (CVEs);
wherein to adapt the execution environment is based on a remedial action in response to the identified CVEs.

5. The machine-readable storage medium of claim 1, wherein the security intents define properties related to least one of: confidentiality, integrity, isolation, audibility, and infrastructure, and wherein the properties correspond to respective numeric value ranges or pre-defined values for the security intents.

6. The machine-readable storage medium of claim 1, wherein the security intents are provided within a Helm Chart or a Docker compose file associated with a container image used to execute the workload.

7. The machine-readable storage medium of claim 1, wherein the instructions further cause the processing circuitry to:
monitor the execution of the workload with a trust coordination framework.

8. The machine-readable storage medium of claim 7, wherein to adapt the execution environment and control the execution of the workload are based on use of a security policy provided from a plurality of security policies, wherein the computing node is one of a plurality of computing nodes in a cluster, and wherein the security policy is applicable to the plurality of computing nodes.

9. The machine-readable storage medium of claim 8, wherein the instructions further cause the processing circuitry to:
determine a selected node of the plurality of computing nodes in the cluster;
forward the identified security intents to the selected node; and
forward the workload or results from the execution of the workload to the selected node.

10. The machine-readable storage medium of claim 1, wherein the processing circuitry is configured to execute the workload, and wherein the processing circuitry includes at least one: central processing unit (CPU), graphics processing unit (GPU), accelerator.

11. An orchestrator node configured to implement security intents for execution of a workload in a cluster, comprising:
processing circuitry; and
a memory device including instructions embodied thereon, wherein the instructions, which when executed by the processing circuitry, configure the processing circuitry to cause operations that:
identify a workload for execution;
identify security intents that define levels of respective security requirements for the execution of the workload;
select a computing node of the cluster for execution of the workload, based on the identified security intents;
adapt an execution environment of the selected computing node, based on the identified security intents; and
dynamically monitor the execution of the workload on the selected computing node, to verify compliance with the identified security intents in response to changed security conditions during the execution of the workload.

12. The orchestrator node of claim 11, wherein the execution environment includes at least one: container, virtual machine, operating system.

13. The orchestrator node of claim 11, wherein the operations to adapt the execution environment include operations to: isolate the execution environment on the selected computing node; or perform a security update to the execution environment.

14. The orchestrator node of claim 11, wherein the instructions further configure the processing circuitry to cause operations that:
perform scanning of the execution environment and the workload to identify common vulnerabilities and exposures (CVEs);
wherein the operations to adapt the execution environment are further based on a remedial action in response to the identified CVEs.

15. The orchestrator node of claim 11, wherein the security intents define properties related to least one of: confidentiality, integrity, isolation, audibility, and infrastructure, and wherein the properties correspond to respective numeric value ranges or pre-defined values for the security intents.

16. The orchestrator node of claim 11, wherein the security intents are provided within a Helm Chart or a Docker compose file associated with a container image used to execute the workload.

17. The orchestrator node of claim 11, wherein the operations to dynamically monitor the execution of the workload are implemented with a trust coordination framework hosted at the orchestrator.

18. The orchestrator node of claim 17, wherein the operations to adapt the execution environment and control the execution of the workload are based on use of a security policy provided from a plurality of security policies, and wherein the security policy is applicable to a plurality of computing nodes in the cluster.

19. The orchestrator node of claim 18, wherein the instructions further configure the processing circuitry to cause operations that:
determine another computing node of the plurality of computing nodes in the cluster;
forward the identified security intents to the another computing node; and
forward the workload or results from the execution of the workload to the another computing node.

20. The orchestrator node of claim 11, wherein the cluster includes multiple sets of processing circuitry corresponding to a respective computing node, and wherein the multiple sets of processing circuitry include at least one: central processing unit (CPU), graphics processing unit (GPU), accelerator, at the respective computing node.
